(19) United States
(12) Patent Application Publication
(10) Pub. No.: US 2005/0028036 A1
(43) Pub. Date: Feb. 3, 2005

(54) Program debug apparatus, program debug method and program

(76) Inventor: Kohsaku Shibata, Takatsuki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/901,094

(22) Filed: Jul. 29, 2004

(30) Foreign Application Priority Data
Jul. 30, 2003 (JP) 2003-283117

(51) Int. Cl. G06F 11/30

(52) U.S. Cl. 714/38

(57) ABSTRACT

In the case where a break instruction is a predicated instruction whose execution condition is not satisfied in a program debug apparatus, the target program is executed again up to the predicated instruction, that is to be executed next, whose execution condition is satisfied or the non-predicated instruction that is to be executed next.

### BACKGROUND OF THE INVENTION

(1) Field of the Invention

The present invention relates to a program debug apparatus for helping a software developer with program development by displaying the execution status of the program at the time when the program is executed or stopped arbitrarily, especially relates to a debug apparatus for a processor having predicated instructions.

(2) Description of the Related Art

The debug apparatus for displaying the execution status of the program by temporally stopping the execution of the program that operates in the processor is useful in program development. In the program debug apparatus, break points are set at arbitrary instructions of the program and the program is temporally stopped. Here is Japanese Laid-Open Patent application No. 2001-154877 as literature of the related art concerning the present invention.

The interruption control apparatus (program debug apparatus) disclosed in this above-mentioned document comprises a judgment unit that judges whether the predicated instruction is satisfied or not and controls the occurrence of the break interruption is disclosed based on the judgment result. Here, the predicated instruction includes the specification of the execution condition, and it is not executed in the case where the execution condition is not satisfied, in other words it is executed only in the case where the execution condition is satisfied. Also, as the execution condition, a single flag value in the status register of the processor is specified. The interruption control apparatus of the above-mentioned patent literature 1 can prevent any break interruption from occurring in the case where the execution condition is a not-satisfied predicated instruction. As a result, it is possible not to interrupt the program at the predicated instruction. In this way, it is possible not to interrupt the program at any unnecessary locations in debug operation.

With the above-mentioned related art, an operator of a debug operation must specify whether the execution conditions of the instructions that are to become break points are evaluated or not as to all the break points at the time when setting break points, there is a case where the program does not stop at the locations desired by the operator of the debug operation unless the operator pays enough attention to the operation. Therefore, there is a problem that the workload of the debug operator increases and thus the efficiency of the debug operation deteriorates.

For example, there occurs an operation for specifying whether the execution condition of the respective one of the break points is specified or not. Also, there is a case where additional operation is forced in the case where the program stops at a predicated instruction, the operation is that the operator of the debug operation checks which break point current predicated instruction is, whether it is really specified that the execution condition should be evaluated, whether the program is really stopped by that the execution condition is satisfied and the like.

Also, in the case where the locations of the stopped predicated instructions in the program list are displayed in the debug apparatus, there is a problem that the operator of the debug operation cannot immediately judge whether current predicated instruction has specified that the execution condition is really evaluated and whether the program is really been stopped by that the execution condition is satisfied.

### SUMMARY OF THE INVENTION

An object of the present invention is to provide a program debug apparatus that reduces the workload of the operator of the debug operation and improves the efficiency of the debug operation.

In order to solve the above-mentioned problem, the program debug apparatus of the present invention is for debugging a program including a predicated instruction having an execution condition, comprising: an instruction judgment unit operable to judge whether an instruction, throughout the program, stopped by a break condition irrelevant to the execution condition is a predicated instruction or not; a condition judgment unit operable to judge whether the execution condition is satisfied or not in the case where the instruction is judged as a predicated instruction; and a determination unit operable to determine the instruction as a break instruction in the case where the execution condition is judged as satisfied and determine a next instruction to be executed immediately after the instruction as a break instruction in the case where the execution condition is judged as not satisfied.

This structure is useful for improving the efficiency of the debug operation by the operator of the debug operation because the program does not stop at instructions that do not affect the execution of the target program. For example, in the case where the operation of the target program is confirmed while the operator of the debug operation is executing the single step, it is possible to follow the process of the target program without confirming whether the execution condition of the predicated instruction is confirmed or not.

Here, the program debug apparatus may further comprise an execution unit operable to control program execution up to an instruction immediately before the next instruction, the next instruction is executed next earliest time and one of a predicated instruction whose execution condition is satisfied and a non-predicated instruction in the case where the execution condition of the instruction is judged as not satisfied by the condition judgment unit.

With this structure, the debug operation is made to be more efficient because it is possible to stop the target program and the operator of the debug operation can perform the forced break operation of the target program at arbitrary locations even in the case where the target program is executing the passage instruction. The passage instruction is being a predicated instruction whose execution condition is not satisfied is passed through.

From here, in the case where there is an unpermitted description of “instruction to be executed (executed instruction)”, the description is regarded as “instruction whose execution condition is (was) satisfied or non-predicated instruction”. Also, from here, in the case where there is an unpermitted description of “next execution instruction”, the description is regarded as “instruction to be executed next earliest time”.

Here, in the case where the execution condition is judged as not satisfied, the determination unit may calculate an address of the next instruction, the next instruction is executed next earliest time and one of a predicated instruction whose execution condition is satisfied and a non-predicated instruction, and determine the calculated address as an instruction address of the break instruction.

With this structure, the debug operation is made to be more efficient because the overhead for executing the target program again can be omitted and the debug operation time by the debug operator can be shorten after the target program stops at a passage instruction.

Here, wherein the execution unit may include: a conditional break setting unit operable to set a conditional break as an address of an instruction stopped by the break condition in the case where the instruction is judged as a predicated instruction by the instruction judgment unit, the conditional break breaking programs only when a target break instruction is a predicated instruction and the execution condition is satisfied; a conditional single step execution unit operable to execute a conditional single step that breaks by step execution of the predicated instruction whose execution condition is satisfied or the non-predicated instruction; and a break resetting unit operable to reset the conditional break that is set by the conditional break setting unit after the conditional single step execution performed by the conditional single step execution unit.

With this structure, it becomes easier for the first program debug apparatus to respond to various processors because the processing, which is for analyzing whether or not the execution condition of the target program stops at the predicated instruction whose execution condition is not satisfied, becomes unnecessary, and the processing that depends on the instruction sets of the processor where the target program operates. In this way, it is possible to reduce the number of man-hours for developing the first program debug apparatus.

Here, the program debug apparatus may further comprise: a flag storing unit operable to store a flag that can be set by a user; and an inhibiting unit operable to inhibit an operation of the instruction judgment unit, the condition judgment unit and the determination unit in the case where a predetermined value is set at the flag of the flag storing unit.

With this structure, the debug operation is made to be more efficient because the debug operator can flexibly change the style of the debug operation depending on which debug operation of the following two is performed: debug operation of the instruction execution flow focusing on the change of the program counter; and the logical debug operation focusing on the instruction to be executed. Also, the debug operator can surely stop the target program when the instruction execution flow passes through the locations where break points are set at the time of performing debug operation of the instruction execution flow that focuses on the change of the program counter by resetting the flag, and thus the break points are automatically made to be more efficient for the debug operation of the instruction execution flow. This makes the debug operation more efficient.

Here, the program debug apparatus may further comprise a flag changing unit operable to change the value of the flag of the flag storing unit according to a program display status in a display unit.

Here, the flag changing unit may set the predetermined value at the flag in the case where a window for displaying a source program is displayed as the display status and set a value except the predetermined value at the flag in the case where the display window of the source program is not displayed as the display status.

Here, the flag changing unit may set the predetermined value at the flag in the case where a display window of a source program is selected as the display status and set a value except the predetermined value at the flag in the case where the display window of the source program is not selected as the display status.

Here, the flag changing unit may set the predetermined value at the flag in the case where a display window of a source program is selected as the display status and set a value except the predetermined value at the flag in the case where the display window of an assembly program is selected as the display status.

With this structure, it becomes possible to grasp right which part on the source code the program stops because the possibility of the stoppage by the non-satisfied conditional execution condition is eliminated when the user focuses on the source program even in the case where the user takes the trouble to explicitly set the flag. Further, as the program stops at all the instructions when the user focuses on the assembly code, it becomes possible to easily grasp which assembly code is fetched and included in the instruction pipe line.

Here, the instruction judgment unit may make the judgment on an instruction stopped by a break that is set under a control of the program debug apparatus without notifying a user, the break being a temporary break irrelevant to whether the execution condition is satisfied or not.

With this structure, the debug operator can stop the program at desirable locations because the possibility that the target program is executed by passing through a temporary break irrespective of an instruction for setting a temporary break at the time of performing the return execution for repeating the execution until the single step execution or the function at the level of C source code finishes, and the number of man-hours in debugger development is reduced as there is no need to judge the type of the instruction for setting the temporary break and thus debugger development is simplified.

Here, the program debug apparatus may store a predetermined number that can be set by a user, wherein the determination unit determines the instruction stopped by the break condition as a break instruction in the case where an execution condition of the instruction is judged as not satisfied by the condition judgment unit and the break instruction stopped by a break condition is followed by the predetermined number or more of predicated instructions whose execution conditions are not satisfied.

With this structure, at the time of changing the break addresses, the old break address is changed to the new break address that is not too distant from the instruction at which a break address is being executed, for the debug operator, to instinctively recognize the new address. This enables indicating a result that is easily predictable by the debug operator, and thus the debug operation is made to be more efficient.

Here, the program debug apparatus may further comprise: a final execution instruction searching unit operable to search an instruction that is executed last immediately before a program break in the case where a break instruction is determined by the determination unit, the instruction being a predicated instruction whose execution condition is satisfied or a non-predicated instruction; a break line judgment unit operable to judge at which line of a source code of a high level language the program stops based on an address of the instruction searched by the final execution instruction searching unit; and a display control unit operable to control a display unit to display the judged line.

With this structure, the debug operator can accurately recognize which source code is executed because the source code line corresponding to the passage instruction, that is the source code line not-to-be executed is not regarded as the break source code line, and thus the debug operation is made to be more efficient. Also, the break address is not changed based on the passage instruction, the debug operator can observe the accurate program counter at the time of stopping the target program.

Here, the break line judgment unit may judge at which line of a source code of a high level language the program stops based on an address specified by a present program counter in the case where the final execution instruction searching unit fails in searching, and the display control unit may control the display unit to display that a source code line is not executed in the case where the final execution instruction searching unit fails in searching.

This structure can make it easier for the debug operator to instinctively recognize the present location in the target program even in the case where no executed instruction is included in the target program, and thus the debug operation is made to be more efficient. Also, the program stops at source code lines not to be executed only in the case where the search of the final execution instruction fails unlike the case where the program always stops also at source code lines not to be executed, which shorten the time needed for the debug operator to recognize the source code lines not to be executed, and thus the debug operation is made to be more efficient.

In order to solve the problem, the data processing apparatus of the present invention, which is connected to the program debug apparatus, is the data processing apparatus for executing the target program and comprises an execution flag storing unit that stores the instruction execution flag to be set in the case where an predicated instruction whose execution condition is satisfied is executed and a normal instruction without any execution condition is executed and a final execution instruction address register that stores the address of the lastly executed one of instructions of the predicated instruction whose execution condition is satisfied or the normal instruction without any execution condition.

With this structure, at the time of searching the last execution instruction in the last execution instruction searching unit, the necessity for performing the instruction analysis depending on the processor is eliminated because the number of man-hours, in debugger development, needed for handling a specific processor decreases, and thus the number of man-hours in the case where the debugger deals with another processor decreases. Also, as it can omit the search processing to the trace data comparing with the second program debug apparatus for searching the final execution instruction using the trace data, the third program debug apparatus can be simplified.

Here, the data processing apparatus may further comprise: an event specification register operable to specify an arbitrary selected one or more interruption factors; an interruption factor register operable to store an interruption request signal; and an update inhibiting unit operable to inhibit update of the final execution instruction address register and the instruction execution flag storing unit in the case where at least one of the interruption factors specified in the event specification register is corresponding to the interruption request signal stored in the interruption factor register.

With this structure, the final execution instruction address register and the instruction execution flag automatically stores its status at the time when the debug event interruption request occurs, for example, at the time when the break point interruption occurs, also, it becomes possible to detect instructions that should be detected in the final execution instruction searching unit even in the case where no special step is taken because the update is automatically reunited at the time of resetting the registration of the interruption request after the interruption detection.

Here, the data processing apparatus simultaneously executes a plurality of instructions and may further comprise: an address comparator operable to compare the plurality of instructions to be simultaneously executed; and a selection output unit operable to select a largest address and output the largest address to the final execution instruction address register as a result of address comparison by the comparator.

With this structure, it is possible to store the address of the executed instruction located in the most forward direction in the target program that operates in the processor that can execute a plurality of instructions in parallel and it is possible to inform the debug operator of up to which instruction the target program has already been executed in detail. This makes the debug operation more efficient.

Here, the data processing apparatus may further comprise: a counting unit operable to count the number of instructions indicating how many contiguous predicated instructions whose execution conditions are not satisfied are passed through; and a break interruption generating unit operable to generate a break interruption in the case where the number of contiguous passage instructions exceeds the predetermined value.

With this structure, for example, the program can stop at appropriate instructions even in the case where a single step execution is performed from the break location after long contiguous instructions whose execution conditions are not satisfied, and the debug operation is made to be more efficient.

Here, the data processing apparatus may further comprise: a break point passage unit operable to disable a break point set at a predicated instruction whose execution condition is not satisfied; and an enabling unit operable to enable the counting unit after the predicated instruction whose execution condition is not satisfied passes through the break point.

With this structure, for example, the program breaks within a certain range after passing through the break point even in the case where break points are set at the last instruction of the target program in a status where passage instructions are set at the area other than the area at which the target program in the instruction memory is placed and the last instruction of those instructions is a passage instruction, which enables the debug operator to easily recognize that the last instruction is executed. In this way, the debug operation is made to be more efficient.

Here, the break interruption generating unit may reset the counting unit at the time when the break interruption occurs.

With this structure, setting a break point at the instruction to be passed through entails the occurrence of the number of passage instruction excess break interruption even in the case where no unit that generates the break interruption to the predicated instructions whose execution conditions are not satisfied. In this way, the necessity for preparing the exclusive unit that specifies whether or not the instruction to become a break should generate a break on the predicated instruction whose execution condition is not satisfied.

Here, the data processing apparatus may further comprise a disabling unit operable to disable the counting unit in the case where an address of the target instruction of the break point is smaller than an address of one of a predicated instruction and a non-predicated instruction during a simultaneous execution of (i) the target instruction of a break point passed through by the break point passage unit and (ii) one of the predicated instruction whose execution condition is satisfied and the non-predicated instruction.

With this structure, it becomes possible to correctly reflect the sequence of instructions whose execution conditions are evaluated in parallel in the target program, the program being operated in the processor capable of executing a plurality of instructions in parallel, and enable the debug operator to instinctively understand the reason for the occurrence of the number of passage instruction excess break interruption, which makes the debug operation more efficient.

Also, the compiler of the present invention is the compiler for generating the object program based on the source program and comprises a counting unit that counts the largest number of the contiguous predicated instructions in the generated object program and a generating unit that generates the debug information including the largest number.

Also, the program of the present invention is the target program by the program debug apparatus, and the program includes the debug information indicating the largest number of the contiguous predicated instructions in the program.

With this compiler and this program, it is possible to provide the program debug apparatus or the data processing apparatus with the debug information for improving the accuracy in detecting run away of the program.

Also, the program debug method for the present invention and the program for causing a computer to execute the method have similar structure, action and effect.

With the embodiment of the present invention made like mentioned above, there rarely occurs the status where the target program stops in a source code line corresponding to the instruction to be executed in the display because it automatically controls whether the program debug apparatus passes through the break point at the predicated instructions whose execution conditions are not satisfied, which enables the debug operator to easily and instinctively recognize the execution path of the target program, and thus the debug operation is made to be more efficient.

Also, in a special case where a break point is set at locations after contiguous passage instructions or other cases, it is possible to automatically make a target program become a break within the range of debug operator's expectation so that the debug operator does not lose track of the execution path of the target program.

### FURTHER INFORMATION ABOUT TECHNICAL BACKGROUND TO THIS APPLICATION

The disclosure of Japanese Patent Application No. 2003-283117 filed on Jul. 30, 2003 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing the external view of the program debug system 1 in an embodiment of the present invention.

FIG. 2 is a diagram showing the external view of the program debug system 5 in the embodiment of the present invention.

FIG. 3 is a diagram showing an example of the display description after a simulation software is started in the program executing apparatus 2.

FIG. 4 is a diagram showing an example of the display description at the time while the debug software is being executed in the program debug apparatus 2.

FIG. 5 is a diagram showing a conversion example of a source code of the target program.

FIG. 6 is a block diagram showing the structure of the program executing apparatus 6 and the program debug apparatus 2 in the first embodiment.

FIG. 7 is a diagram showing an example of the display description of the command input window W3.

FIG. 8 is a flow chart of the first after-break processing in the program debug apparatus 2.

FIG. 9 is a flow chart of the second after-break processing in the program debug apparatus 2.

FIG. 10 is a flow chart of the third after-break processing in the program debug apparatus 3.

FIG. 11 is a flow chart of the next execution instruction address calculating process in the program debug apparatus 2.

FIG. 12 is a flow chart of the first forced break processing in the program debug apparatus 2.

FIG. 13 is a diagram showing an example of the display description of the code display window W1 and the source display window W4.

FIG. 14 is a flow chart of the second forced break processing in the program debug apparatus 2.

FIG. 15 is a flow chart of the single step execution processing instruction by instruction in the program debug apparatus 2.

FIG. 16 is a flow chart of the single step execution processing source code line by source code line in the program debug apparatus 2.

FIG. 17 is a diagram showing an example of the display description of the code display window W1 and the source display window W4.

FIG. 18 is a flow chart of the return execution processing in the program debug apparatus 2.

FIG. 19 is a diagram showing an example of the display description of the code display window W1 and the source display window W4.

FIG. 20 is a flow chart of the break point processing in the program debug apparatus 2.

FIG. 21 is a flow chart of the passage detection processing of the break point in the program debug apparatus 2.

FIG. 21A is a diagram showing an example of the display description of the command input window W3.

FIG. 21B is a flow chart showing a flag automatic setting processing by the control unit in auto flag mode.

FIG. 21C is an illustration showing the outline of the compiler in the present embodiment.

FIG. 21D is a flow chart showing the compiling processing in the case where there is an option specification for ordering the generation of the debug information.

FIG. 21E shows an example of the source program.

FIG. 21F shows an example of the execution foam file showing the compiling result of the source program.

FIG. 21G is an illustration showing an example of the debug information 11b.

FIG. 22 is a block diagram showing the structures of the program executing apparatus 206 and the program debug apparatus 202 in the second embodiment of the present invention.

FIG. 23 is a flow chart of the break source code line display processing in the source code display unit.

FIG. 24 is a diagram showing an example of the display description of the code display window W1 and the source display window W4.

FIG. 25 is a diagram showing an example of the display description of the code display window W1 and the source display window W4.

FIG. 26 is a block diagram showing the structures of the program executing apparatus 306 and the program debug apparatus 302 in the third embodiment of the present invention.

FIG. 27 is a block diagram showing the structure of the execution address generating unit 370.

FIG. 28 is a block diagram showing the structure of the update inhibit signal generating unit 360.

FIG. 29 is a block diagram showing the structures of the program executing apparatus 406 and the program debug apparatus 402 in the fourth embodiment of the present invention.

FIG. 30 is a block diagram showing the structure of the break signal generating unit 470.

FIG. 31 is a block diagram showing the structure of the break control unit 460.

FIG. 32 is a block diagram showing an example of the display description of the code display window W1.

### DESCRIPTION OF THE PREFERRED EMBODIMENT(S)

### First Embodiment

<External View of the Program Debug System>

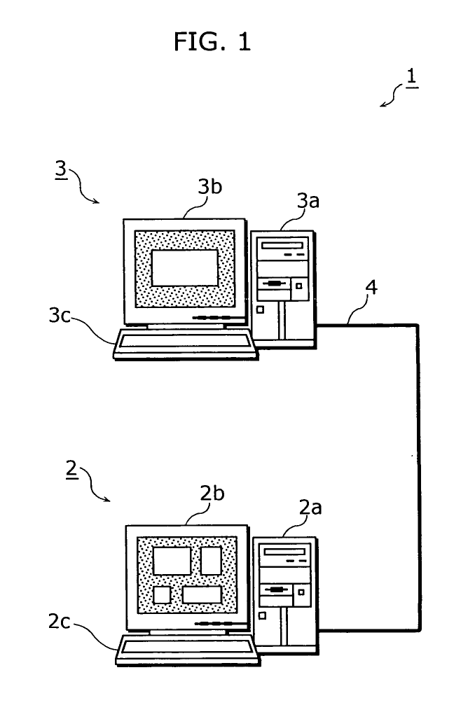

FIG. 1 is a diagram showing the external view of the program debug system in the first embodiment of the present invention. The program debug system 1 in the figure comprises a program debug apparatus 2 and a program executing apparatus 3.

The program debug apparatus 2 comprises a main apparatus 2a, a display apparatus 2b and an input apparatus 2c. The main apparatus 2a is an apparatus that receives input from the debug operator via the input apparatus 2c, controls the execution of the target program in the program executing apparatus 3 and display the execution status using the display apparatus 2b.

This program debug apparatus 2 is structured so that it uniformly inhibits a break at a predicated instruction whose execution condition is not satisfied in the whole target program concerning the break in the execution of the target program. Here, the predicated instruction is an instruction including the specification of an execution condition, and it is not executed in the case where the execution condition is not satisfied, in other words, it is executed only in the case where the execution condition is satisfied. As an execution condition, a flag value in the status register of the processor is specified. Also, the predicated instruction whose execution condition is not satisfied is called passage instruction from here.

The program debug apparatus 2 in the embodiment comprises a special flag (called a skip flag from here) and structured in a way that it uniformly inhibits a break at a passage instruction in the whole target program in the case where a skip flag is 1 while it uniformly permits a break at a passage instruction in the whole target program in the case where a skip flag is 0. The default value of the skip flag is 1.

The program execution apparatus 3 comprises a main apparatus 3a, a display apparatus 3b and an input apparatus 3c and is a data processing apparatus for executing a simulation software for simulating operations of a processor (or an evaluation board with a processor) for executing a target program, and is controlled by the program debug apparatus 2 via the LAN cable 4. In the case where a target system is still in a designing process, the program executing apparatus 3 can serve as a substitute of the target system.

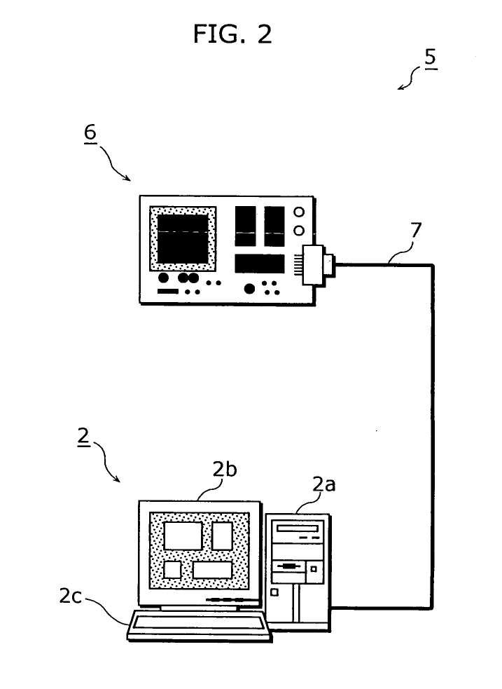

FIG. 2 is a diagram showing the external view of another program debug system 5. The program debug system 5 of the figure differs from the one in FIG. 1 in that the program debug system 5 has a program executing apparatus 6 instead of the program executing apparatus 3. The program executing apparatus 6 is a processor or an evaluation board with a processor and is controlled by the program debug apparatus 2 via a connection cable 7.

The program debug apparatus 2 basically operates in a same manner in both the case where it is connected to the program executing apparatus 3 that is a simulator as shown in FIG. 1 and the case where it is connected to the program executing apparatus 6 that is a processor (or an evaluation board) as shown in FIG. 2.

Also, it is possible to execute the above-mentioned simulation software on a computer of the program debug apparatus 2 and use the program executing apparatus 3 concurrently.

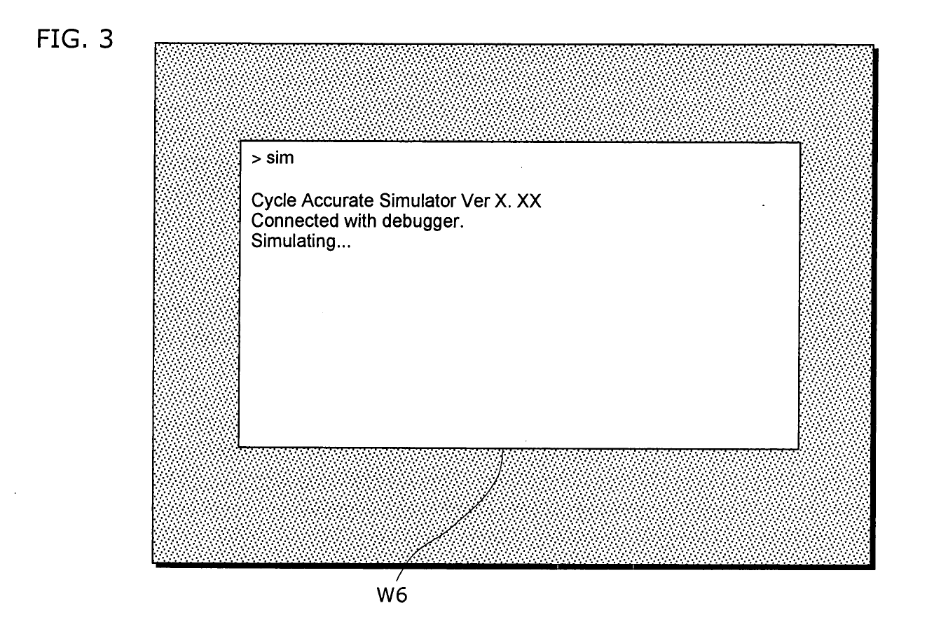

FIG. 3 shows an example of the display description immediately after starting the simulation software in the program executing apparatus 3. As shown in the figure, W6 is a console window and displays that the simulation software is being executed. The program executing apparatus executes (simulates) a target program in this status. This enables a software developer to use this program executing apparatus 3 via the program debug apparatus 2.

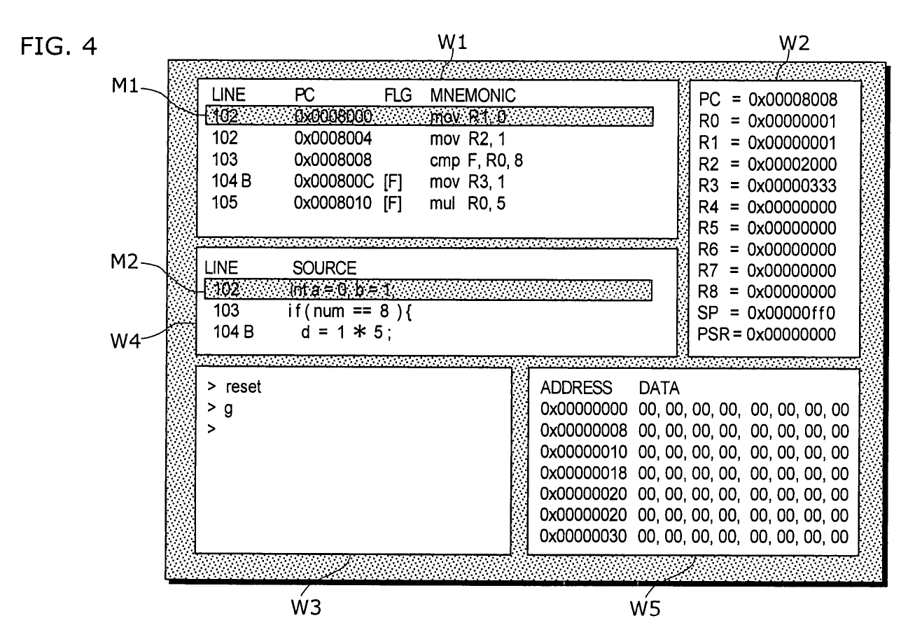

FIG. 4 shows an example of the display description during the debug software is being executed in the program debug apparatus 2. In the figure, W1 is a code display window displaying an instruction code of the target program, W2 is a register description display window for displaying register data, W3 is a command input window for inputting the command for respective one of simulations by user operations, W4 is a source display window displaying the source target program, and W5 is a memory description display window for displaying memory data.

M1 is a break line mark showing an unexecuted leading instruction (called break instruction from here) in a target program whose execution is stopped and M2 is a break line mark showing a source code line in the source program corresponding to the break instruction.

The code display window W1 displays a program counter value (the column of PC in the figure) showing an instruction address concerning the target program, a line number (the column of LINE), a flag (the column of FLG), a mnemonic (the column of MNEMONIC) and the like and displays a break instruction mark M1. In the figure, the instruction of line 104 ([!F] mov R3,1) and the instruction of line 105 ([!F] mov R0, 5) are predicated instructions. Here, the flag [!F] shows a value of flag F in the status flag register included in a processor where the target program is operated and shows the condition of the predicated instruction. In the program example in the figure, the flag F is true or false by a comparison instruction (cmp instruction, line 103) immediately before the predicated instruction. The predicated instructions of line 104 and line 105 are executed only in the case where a flag F is true respectvely. In this way, flag F is used for, for example, an execution statement and the like depending on a condition of the if statement in line 103 in the source display window W4 by reflecting the result of whether the condition in the conditional branch is satisfied or not on the value of flag F. Also, [!F] is displayed instead of [!F] in the case where the instruction is executed only on condition that flag F is false.

### Target Program in the First Embodiment

There is a case where a target program is written in C language, and a C language compiler converts the program written in C language into an assembly language corresponding to a machine language that can be understood by a processor. Further, the assembly language is converted into a machine language that can be executed on the processor by the assembler and the linker.

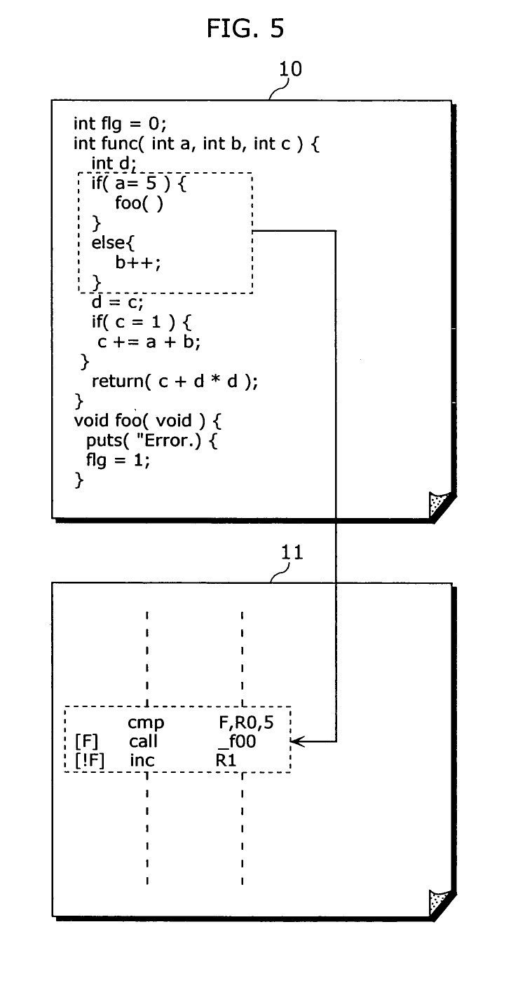

FIG. 5 shows how the C language compiler converts a part of the C language source code 10 into an assembly language code 11 as an example.

The execution statement depending on the if statement and its condition shown by the dotted square in the C language source code 10 corresponds to the part shown by the dotted square in the assembly language code 11. As explained earlier, the result of whether the condition of a conditional branch is satisfied or not is reflected on the value of flag F. This eliminates the branch instruction from the assembly language code 11 and avoids deterioration in performance by a branch generated when executing a program on the processor.

The instruction with [!F] in the assembly language code 11 is a code corresponding to the execution statement at “then” side of the if statement, while the instruction with [!F] is a code corresponding to the execution statement at “else” side of the if statement.

The program to be debugged includes the C language source code 10 and the like as a part of the source code and is the program made by converting the source code into an execution form file that can be executed by the program executing apparatus 3 or the program executing apparatus 6 using a compiler, an assembler and a linker.

This execution form file and the C language source code are inputted into the program debug apparatus 3. The execution form file is executed by the program executing apparatus 3 or 6. The debug operator performs its debug operation controlling the program executing apparatus 2 or 6 to execute the program via the program debug apparatus 3.

<Structure of the Program Executing Apparatus 6 and the Program Debug Apparatus 3>

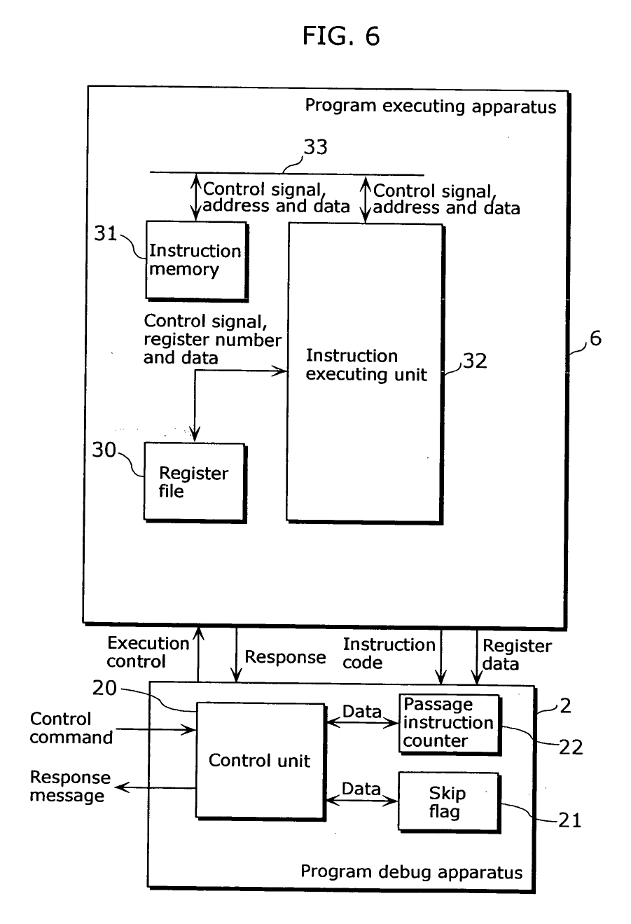

FIG. 6 is a block diagram showing the structure of the main part of the program executing apparatus 6 and the program debug apparatus 3.

The program executing apparatus 6 comprises a register file 30, an instruction memory 31, an instruction executing unit 32 and a bus 33 and executes an instruction by pipeline processing.

The instruction executing unit 32 performs pipeline processing of the flowing four stages: a fetch stage for fetching an instruction from the instruction memory 31 via the bus 33; a decode stage for decoding the fetched instruction; an executing stage for executing the decoded instruction and a write back stage for writing back the execution result to the instruction memory 31. Writing back of the execution result to the register file 30 is performed in the execution stage.

This instruction executing unit 32 processes the predicated instruction in the following way. The predicated instruction is fetched, decoded and then determined whether it should be completely executed according to the result of whether the condition is satisfied or not in the execution stage. In the case where the condition is satisfied, the instruction executing unit 32 (a) reads register data in the execution stage, (b) calculates the data, (c) writes back the calculation result to the register file 30. Also, as necessary, the instruction executing unit 32 writes back the calculation result to a memory in the write back stage. Also, in the case where the condition is not satisfied, (c) in the above-mentioned (a) to (c) is inhibited. Also, writing back in the write back stage is inhibited. In this way, in the case where the condition is not satisfied, the predicated instruction is not substantially executed and prevents any interlock in the pipeline from occurring because no branch is generated.

The program debug apparatus 2 comprises a control unit 20, a skip flag storing unit 21 and a passage instruction counter 22.

The control unit 20 controls the execution of the program in the program executing apparatus 6 according to the control command received by the debug operator in a form of an input via an input apparatus 2c and displays the execution status on the display apparatus 2b as a response message corresponding to the control command.

The skip flag storing unit 21 stores a skip flag for selecting whether the passage instruction should become a break instruction.

The passage instruction counter 22 counts the number of contiguous passage instructions indicating how many predicated instructions whose execution condition is not satisfied are passed through. For example, the passage instruction counter 22 counts down the above mentioned predetermined number as an initial value and returns to the initial value after counting down to 0. This passage instruction counter is used for detecting program ran way. Therefore, the predetermined number should be the maximum number of the contiguous passage instructions that should be regarded as program ran way. In other words, the program debug apparatus 2 may obtain, from the compiler, the maximum number of contiguous predicated instructions in the target program as debug information and set the maximum number at the passage instruction counter 22 as the above-mentioned predetermined number.

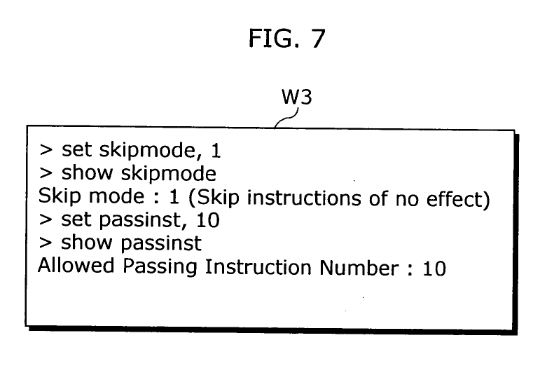

The skip flag storing unit 21 and the above-mentioned number can be freely changed or referred to by inputting the control command to the command input window W3 as shown in FIG. 7. In the figure, “set skipmode, 1” is a control command for setting 1 at the skip flag, and “show skipmode” is a control command for displaying the value of a skip flag. “set passinst, 10” is a control command for setting the above-mentioned predetermined value as 10, and “show passinst” is a control command for displaying the presently set predetermined number.

The above-mentioned control unit 20 excludes the passage instructions in the whole target program from possible break instructions in the case where the skip flag is 1 when controlling the program executing apparatus 6 in the execution of the program. Note that the control unit 20 includes the predicated instructions whose execution conditions are not satisfied in the possible break instructions. This makes it possible to stop executing the program in the case where the program runs away or falls into an infinite loop. Also, this makes it possible to perform debug operation where the execution path of the target program is focused on.

Also, the debug operator can perform a debug operation where the instruction stream is focused on because the passage instructions become break instructions in the case where the skip flag is 0. Therefore, with the skip flag storing unit 21, it becomes possible to easily select an operation of the program debug apparatus according to the debug operation intended by the debug operator.

The program debug apparatus 2 can read out the instruction code from the instruction memory 31 of the program executing apparatus 6 and read out the register data from the register file 30.

The program debug apparatus 2 can control the program executing apparatus 6 concerning the execution control of the target program, and the program executing apparatus 6 makes a response to the execution control.

### Structure of the After-Break Processing S1 in the First Embodiment

First, as a characteristic program debug method in the first embodiment of the present invention, the after-break processing S1 will be explained.

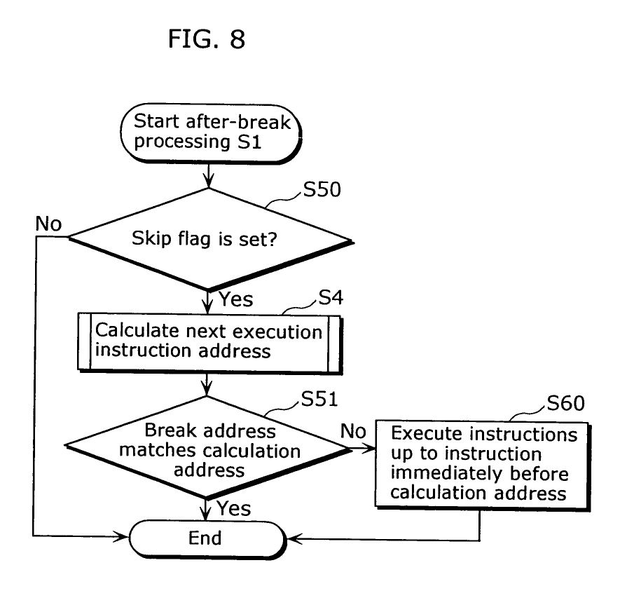

FIG. 8 is a flow chart showing the description of the after-break processing S1. This after-break processing S1 is the processing, executed in the program debug apparatus 2, included in, for example, the single step execution instruction by instruction, the single step execution source line by source line, the forced break processing and the break point processing, and it is executed immediately after stopping the target program regarding the instruction address of the decode PC (program counter) as a judgmental standard. The break regarding the instruction address of the decode PC as a judgmental standard is a well-known technique and the judgment is made irrespective of the result of whether the condition of the predicated instruction is satisfied or not. This break is called interim break, the unexecuted leading instruction at the time of the interim break is called the interim break instruction and the address of the interim break instruction is called the interim break instruction address from here, for convenience in the explanation.

The control unit 20 performs the after-break processing S1 so as to change the break location of the target program to the address of the instruction to be executed next earliest time, (that is the unexecuted instruction to be executed next earliest time other than the passage instructions) in the case where the interim break is a passage instruction.

In the figure, the control unit 20 judges whether the skip flag storing unit 21 is set or not when the after-break processing S1 starts (step S50). As a result, the after-break processing finishes in the case where the skip flag storing unit 21 is not set. In this case, the interim break can be any of the following three instructions: a normal non-predicated instruction; a predicated instruction whose execution condition is satisfied; and a predicated instruction whose execution condition is not satisfied (passage instruction).

In the case where the skip flag storing unit 21 is set, the control unit 20 calculates the address of the next execution instruction (step S4), judges whether or not the address of the calculated next execution instruction matches the break address (the address of the interim break instruction) (step S51), and finishes the after-break processing in the case where the calculation address matches the break address. The case where the calculation address matches the break address means that the interim break instruction is not a passage instruction, the interim break instruction becomes an official break instruction.

On the other hand, in the case where the calculation address does not match the break address, the control unit 20 makes the program executing apparatus 6 execute the target program up to the location immediately before the calculated next execution instruction (step S60). As this case means that the interim break instruction was a passage instruction, the calculation address instruction becomes a break instruction. In the step S60, the control unit 20 instructs the program executing apparatus 6 in the execution of the passage instruction. As the passage instruction itself is not executed, this instruction progresses the value of the program counter in the program executing apparatus 6, and the decode PC indicates the above-mentioned calculation address (the instruction address of the break instruction).

The after-break processing S1 as mentioned above can make the instruction other than passage instructions a break instruction.

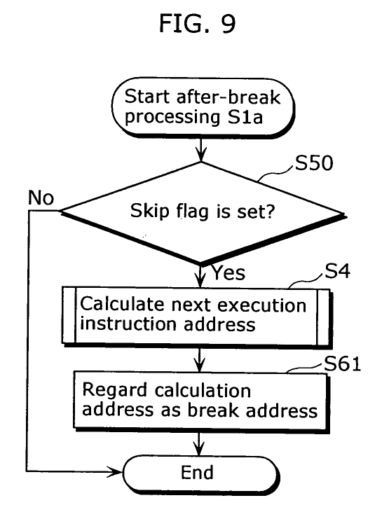

FIG. 9 is a flow chart showing the after-break processing S1a that is a variation of the after-break processing S1. The flow chart shown in the figure differs from FIG. 8 in that it has step S61 instead of step S51 and step S60. In the step S61, the control unit 20 determines the next execution instruction calculated in the step S4 as a break instruction and determines the address as the break address. As step S60 is omitted in FIG. 9, the program is in a break status by an interim break instruction in the program executing apparatus 6 in the case where the interim instruction is a passage instruction, while next execution instruction is determined as a break instruction instead of the passage instruction in an interim break inside the program debug apparatus 2, and its address is determined as the instruction address. As a result, the program debug apparatus 2 can prevent the passage instruction from being displayed as a break instruction. In this case, the break instruction made by the program execution apparatus 6 is different from the break instruction made by the program debug apparatus 2, however, which brings no problem because the difference only relates to whether it passes through the passage instruction or not and because the difference is resolved after the program is executed.

With the method shown in FIG. 9, comparing to the method shown in FIG. 8, it is possible to realize the program more easily because no step for executing the target program.

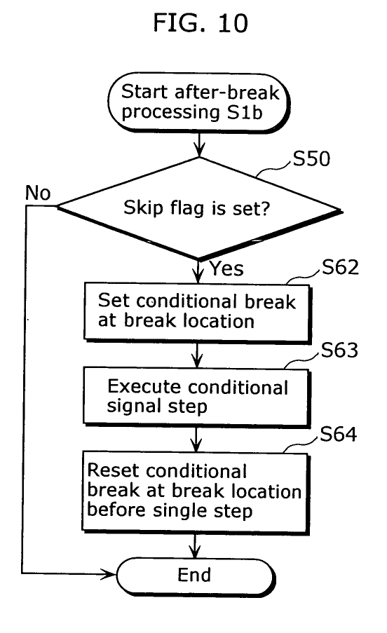

FIG. 10 is a flow chart showing the after-break processing S1b that is another variation of the after-break processing S1.

In the after-break processing S1b in the figure, the control unit 20 finishes the after-break processing in the case where it is judged that no skip flag storing unit 21 is set in the step S50. Also, the control unit 20 sets a conditional break that does not break by any passage instruction at the address of the interim break instruction (step S62) in the case where no skip flag storing unit 21 is set, performs a conditional single step execution that stops at the instruction to be executed next (step S63) after executing or passing the interim break instruction, and resets the conditional break set in the step S62 (step S64).

In the case where the interim break instruction is a passage instruction in the after-break processing S1b shown in FIG. 10, the program does not break at the conditional break set in the step S62, the program counter progresses up to the instruction to be executed next in the conditional single step execution of the step S63, and the program breaks at the conditional break set in the step S62 in the case where the interim break instruction is not a passage instruction. In this way, the same function as S1 and S1a is feasible by using the same procedure in both the case where the interim break instruction is executed and the case where the interim break is passed through.

With the above-mentioned after-break processing S1, S1a or S1b, the control unit 20 changes the break location of the target program to the address where the next execution instruction exists in the case where the interim break instruction was a passage instruction. As a result, in the program debug apparatus 2, it is prevented that a passage instruction is highlighted with the break instruction mark M1 (refer to FIG.4). As a result, at the time of starting the program execution again, the program is executed starting from the instruction highlighted with the break instruction mark, which makes it easier to instinctively recognize the execution path of the target program, and thus the efficiency of the debug operation can be improved.

Note that the structure of the program executing apparatus 6 in FIG. 6 may be the one that does not have the skip flag storing unit 21, and the skip flag judging step S50 may be omitted from FIG. 8, 9 and 10. The above-mentioned effect can be obtained also by this structure.

<Details in the Next Execution Instruction Address Calculating Processing S4>

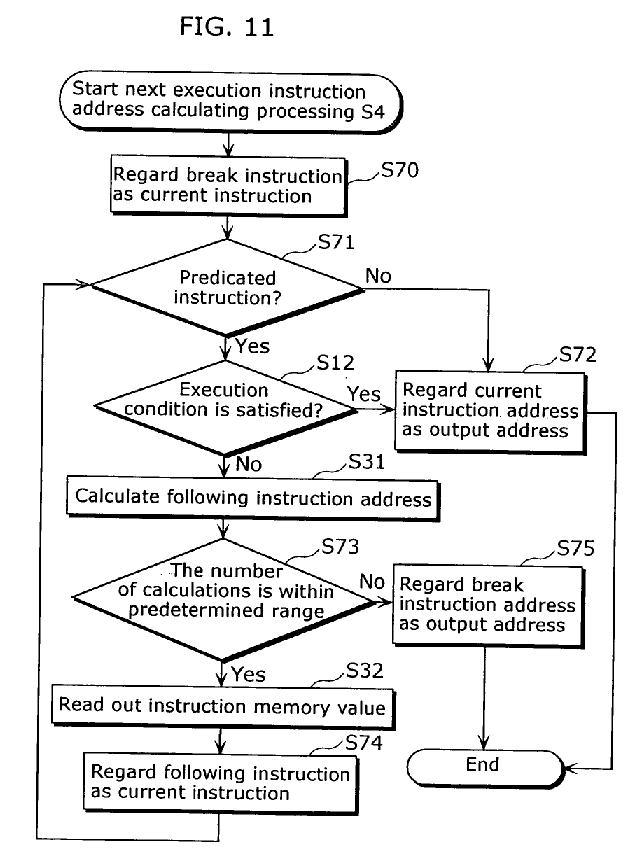

FIG. 11 is a flow chart showing the details of the next instruction address calculating processing in FIG. 8 and FIG. 9. In FIG. 11, the control unit 20 regards the interim break instruction as current instruction (called current instruction to be executed in the following step)(step S70) first, judges whether current instruction is a predicated instruction (step S71), determines the address of current instruction as an output address, that is, a break address (step S72) in the case where current instruction is not a predicated instruction and finishes the next instruction address calculating processing.

Also, in the case where current instruction is a predicated instruction as a result of the step S71, the control unit 20 judges whether the execution condition of current instruction is satisfied or not (step S12), proceeds to the step 572 in the case where the execution condition of current instruction is satisfied, determines the address of current instruction as an output address, that is, the address of the break instruction and finishes the next instruction address calculating processing.

In the case where the execution condition of the current instruction is not satisfied as the result of the step S12, the control unit 20 calculates the address of the following instruction (step S31). Simultaneously to this address calculation, the passage instruction counter 22 counts down by one. Further, the control unit 20 judges whether the number of calculations reaches the predetermined number or not (step S73). This judgment is made based on whether the number of counts of the passage instruction counter 22 is 0 or not. In the case where the number of calculations reaches the predetermined number, the address of the interim break instruction is determined as an output address, that is, a break address (step S75), and the next instruction address calculating process finishes.

Also, in the case where the number of calculations does not reach the predetermined number in the step S73, the control unit 20 reads out the following instruction from the instruction memory (step S32), regards the following read-out instruction as current instruction (step S74) and returns to step S71.

As explained above, in the next execution instruction address calculating processing S4, in the case where the number of loops for calculating the next execution instruction reaches the predetermined number, the address of the interim break instruction is determined as the break address. The reason why the next execution instruction address is calculated in the next execution instruction address calculating processing S4 in this way is as follows: the interim instruction is determined as the break instruction although it is a passage instruction in the case where no instruction to be executed exists around the interim break instruction stemming from program run way or the like, at the time of changing the break address in the after-break processing S1, the break address after the change is within the range of debug operator's expectation, which eliminates the possibility that the debug operator loses track of the present execution path, and thus it is possible to improve the efficiency of the debug operation. In this case, it is desirable that the control unit 20 displays an error message indicating that the number of loops reaches the predetermined number.

<Forced Break Processing>

The case of causing the program debug apparatus 2 to forcibly stop the target program that is being executed in the program executing apparatus 6 according to user operations will be explained.

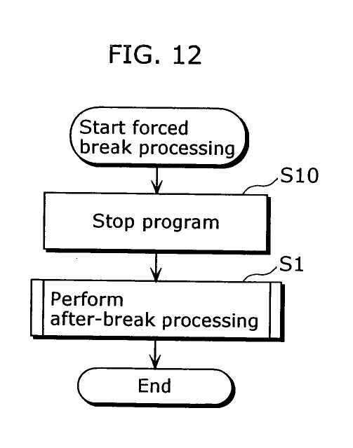

FIG. 12 is a flow chart showing the forced break processing. As shown in the figure, the control unit 20 makes the target program in a status of interim break (step S10) and executes the earlier-mentioned after-break processing S. This eliminates the possibility that the program stops at a passage instruction in the case of forced break.

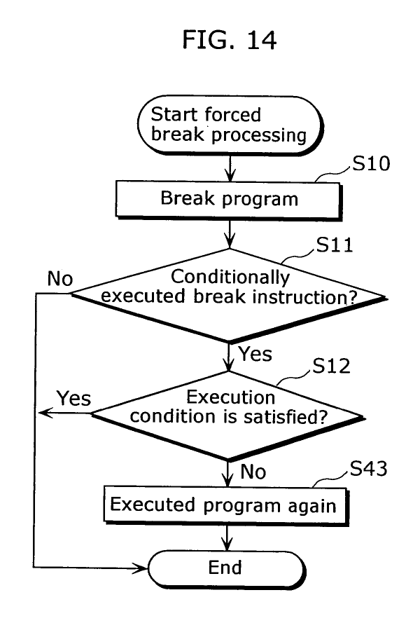

Also, FIG. 14 is a flow chart showing a variation of the forced break processing. In the figure, the control unit 20 makes the target program in a status of interim break (step S10) first. After that, it is judged whether the break instruction is a predicated instruction or not (step S11). As a result, in the case where the break instruction is not a predicated instruction, the forced break processing finishes. It is judged whether the execution condition is satisfied or not (step S12) in the case where the break instruction is a predicated instruction as the result of step S11, while the forced break processing finishes in the case where the execution condition of the break instruction is satisfied as a result. In the case where the execution condition of the break instruction is satisfied as the result of step S12, the target program is executed again (step S43), and the forced break processing finishes. In other words, the embodiment shown in FIG. 14 has a step for canceling the forced break in the case where the break instruction was a passage instruction.

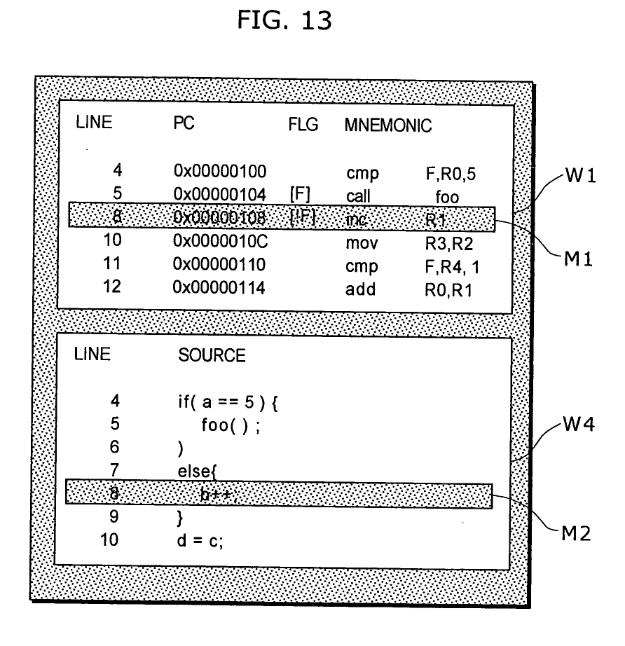

In the case where the program shown in FIG. 5 is a debug target, in the conventional program debug apparatus, at the time of performing a forced break of the target program, it may become a break in a status shown in FIG. 13 even though the execution condition flag F is reset. In this case, as the break code line mark M2 is displayed on the source code line at else side corresponding to the break instruction irrespective that the break instruction is not executed because the execution condition flag F is reset, the debug operator instinctively misrecognize that the else side of the if statement is being executed because the break code line mark M2 is at else side.

However, using a method shown as forced break processing of the present invention can prevent the debug operator from misrecognizing like that because the target program does not stop at a passage instruction.

No forced break operation is cancelled in the forced break processing shown in FIG. 12 although there is a case where the forced break operation of the target program by the debug operator is cancelled in the forced break processing shown in FIG. 14, it is possible to make a response to an operation by the debug operator more smoothly, and thus it becomes possible to improve the efficiency of the debug operation.

<Structure of the Single Step Execution Processing>

The case of causing the program debug apparatus 2 to perform a single step execution of the target program that is being executed in the program executing apparatus 6 instruction by instruction will be explained.

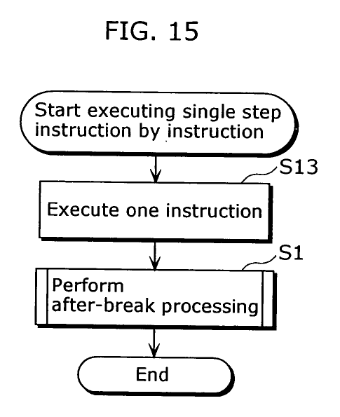

FIG. 15 is a flow chart showing the single step execution processing instruction by instruction.

The program debug apparatus 2 makes the program executing apparatus 6 to execute only a single instruction (step S13) and then execute the after-break processing S1 like in the case of the forced break processing mentioned earlier.

With the above-mentioned structure, the target program does not stop at a passage instruction in the single step execution instruction by instruction, like in the case of the above-mentioned forced break processing, this eliminates the possibility that the break code line mark M2 is displayed on the source code line that is not executed, and thus this can prevent the debug operator from misrecognizing like that.

Next, the case of causing the program debug apparatus 2 to perform a single step execution of the target program that is being executed in the program executing apparatus 6 source code line by source code line will be explained.

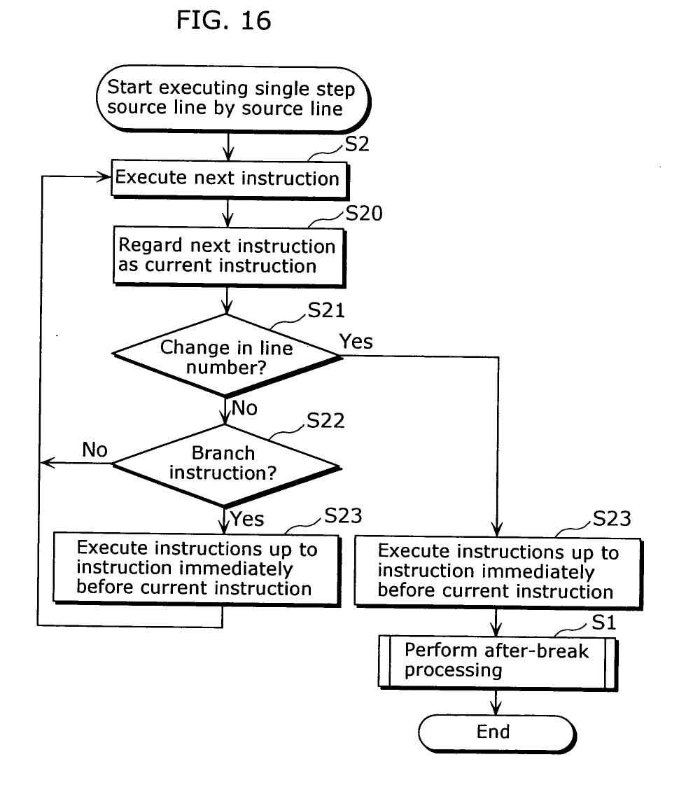

FIG. 16 shows a flow chart of the single step execution processing source code line by source code line in the first embodiment of the present invention.

In the single step execution processing source code line by source code line, the control unit 20 firstly performs the next instruction reading out step S2 of reading out the instruction next to current instruction, the current instruction updating step S20 of focusing on the next instruction read out in the step S2 and the judging step S21 of judging whether the line number of the source code line corresponding to current instruction differs from the line number of the source code line corresponding to the present PC or not.

In the case where line numbers differ from each other as a result of the line number judgment, the control unit 20 performs the re-executing step S23 of executing the target program up to the instruction immediately before current instruction and the earlier-mentioned after-break processing S1 so as to terminate the single step execution source code line by source code line.

In the case where line numbers do not differ from each other as a result of the line number judgment step S21, it is judged whether current instruction is a branch instruction or not (step S22).

In the case where current instruction is not a branch instruction as a result of the judgment, the processing is restarted from the earlier-mentioned next instruction reading out step S2.

In the case where current instruction is a branch instruction as a result of the branch instruction judgment step S22, the earlier-mentioned execution step S23 is executed and the processing is restarted from the earlier-mentioned next instruction reading out step S2.

With the above-mentioned structure, as the target program does not stop at a passage instruction in the single step execution source code line by source code line, like in the case of the earlier-mentioned forced break processing, this eliminates the possibility that a break code line mark M2 is displayed on the source code line that is not executed, and thus it becomes possible to prevent the debug operator from misrecognizing like that.

<Structure of Return Execution Processing>

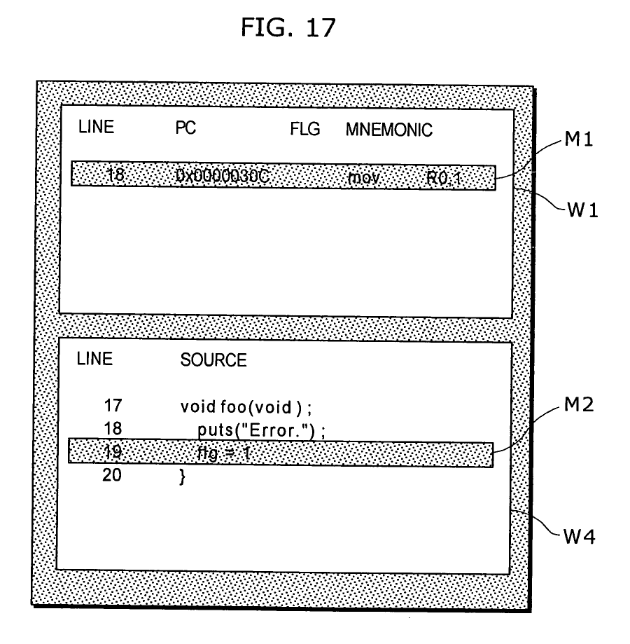

An explanation will be made concerning the case of performing a return execution by the program debug apparatus 2 to execute the program up to the return address of the function in the case where the target program that is being executed in the program executing apparatus 6 stops in the middle of an arbitrary function (function foo in FIG. 17).

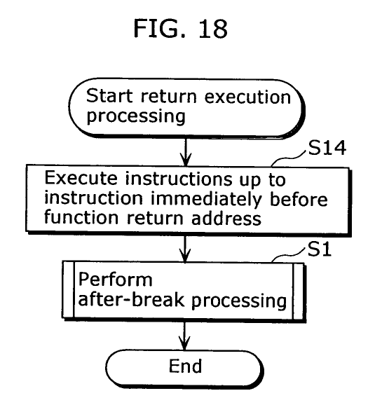

FIG. 18 shows a flow chart of the return execution processing in the first embodiment of the present invention. The program debug apparatus 2 causes the program executing apparatus 6 to execute the program up to the location immediately before the return address of the function (step S14) and then executes the after-break processing S1 like in the case of the earlier-mentioned forced break processing.

As a result, as the target program does not stop at a passage instruction in the return execution instruction by instruction, like in the case of the earlier-mentioned forced break processing, this eliminates the possibility that a break code line mark M2 is not displayed on the source code line that is not executed, and thus it becomes possible to prevent the debug operator from misrecognizing like that.

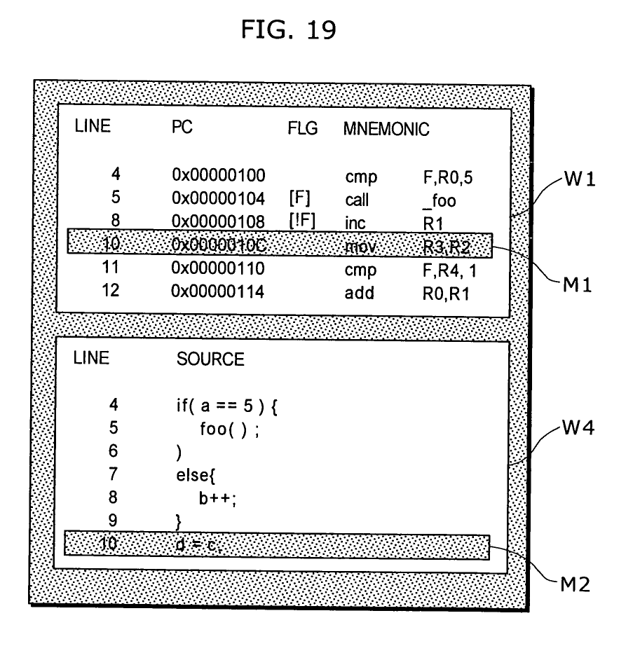

For example, in the case where return execution is performed from the break instruction in the function foo shown by the break code line mark M2 in FIG. 17, in the conventional return execution processing that does not include the after-break processing S1, a break code line mark M2 is actually displayed on the location corresponding to the inc instruction that is not executed as shown in FIG. 13, but in the case of using the return execution processing explained as the first embodiment of the present invention, the break code line mark M2 is displayed on the location corresponding to the mov instruction as shown in FIG. 19.

Here, another return execution processing implementation method will be explained.

In the case where whether the return address of the function is an instruction that is passed through or not is judged and it is judged that the instruction is a passage instruction, a result equivalent to the return execution processing in the first embodiment of the present invention can be obtained by the method for setting a break point at the next execution instruction of the return address of the function.

However, in most cases, a plurality of instructions exist between a break instruction and the instruction of the return address of a function, in the case where the return address of the function is a predicated instruction, judging whether the instruction execution condition of the function return address is satisfied or not is very troublesome.

The reason is that the influence on the execution condition made by the result of the instruction to be executed between the break instruction and the instruction of the function return address on the instruction execution condition of the function return address must be considered.

Therefore, the method for “setting a break point at the execution instruction next to the instruction of the function return address in the case where the instruction is a passage instruction” is less efficient than the method explained as the first embodiment of the present invention.

<Structure of the Break Point Processing>

The case where the program debug apparatus 2 makes the target program executed in the program executing apparatus 6 detect a break point and the target program stops will be explained.

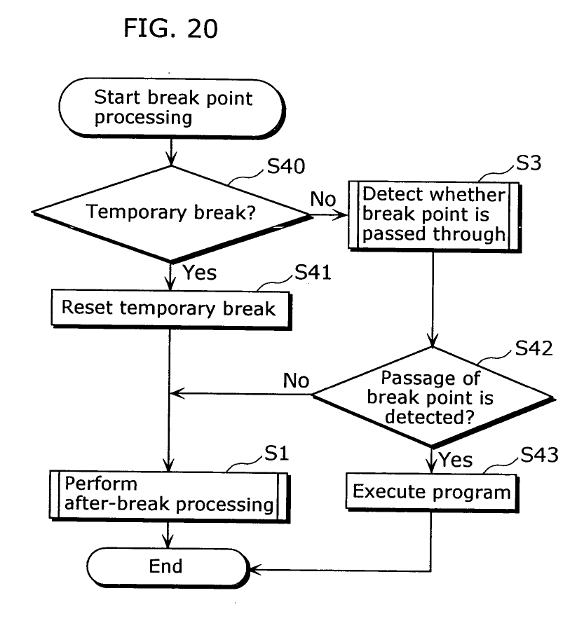

FIG. 20 shows a flow chart of the break point processing.

The control unit 20 judges whether the interim break as a break point is a temporary break or not (step S40). Here, “temporary break” means “interim break” during which a break point (break condition) is reset by the occurrence of the break. The temporary break is used for generating a break interruption, for example, inside the program debug apparatus by the return instruction in response to a user specification or irrespective of user specifications.

In the case where the detected break point is a temporary break as a result of the step S40, the temporary break is reset (step S41) and the break point processing finishes by executing the earlier-mentioned after-break processing S1.

In the case where the detected break point is not a temporary break as a result of the temporary break, whether it passes through the break point or not is detected (step S3), and whether the passage of the break point is detected or not is judged (step S42).

In the case where the passage of the break point is detected as a result of the judgment, the target program is executed again (step S43) assuming that the break processing by the break point is not performed and the break point processing finishes.

In the case where the passage of the break point is not detected as a result of the step s42, the earlier-mentioned after-break processing S1 is executed and the break point processing finishes.

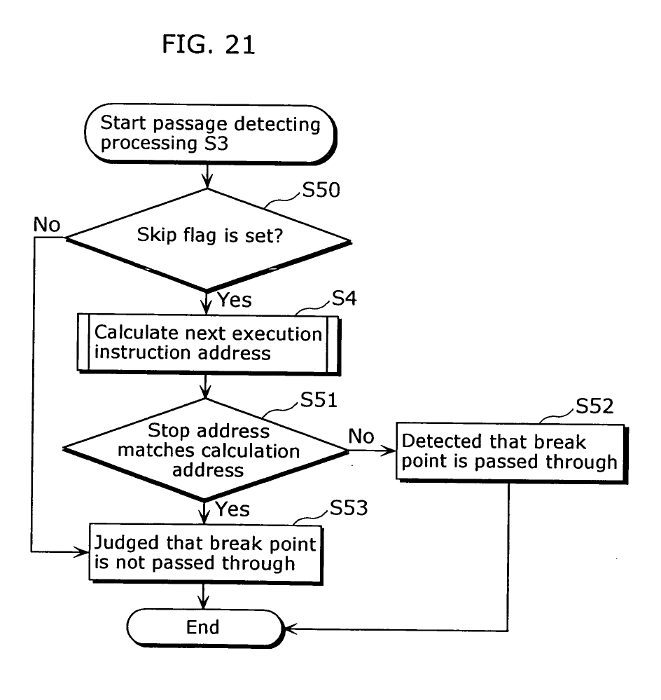

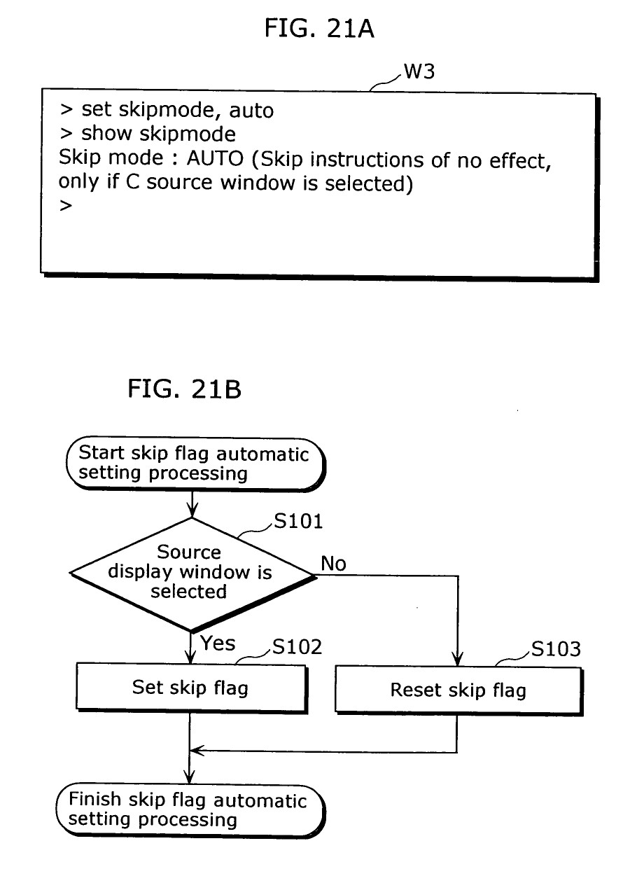

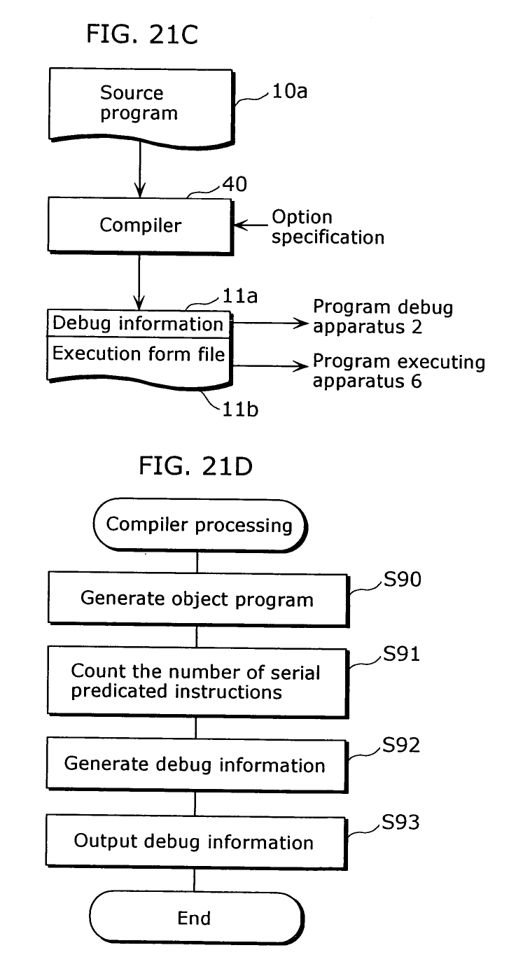

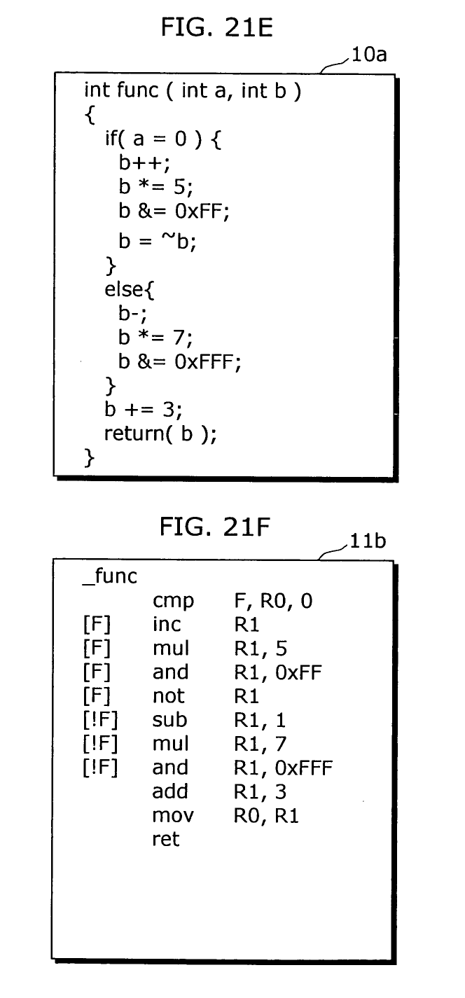

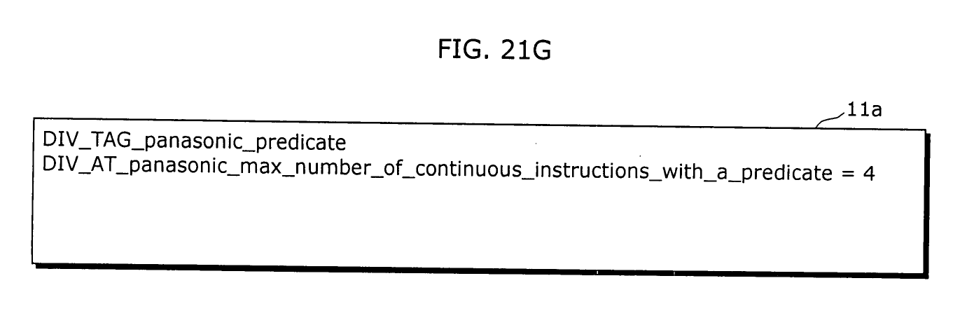

FIG. 21 is a flow chart showing the details of the passage detection judgment processing S3 in FIG. 20. As shown in the figure, the control unit 20 judges whether the skip flag storing unit 21 is set or not first (step S50). In the case where the skip flag storing unit 21 is not set as a result of the judgment, it judges that the break point is not passed through (step S53) and the passage detecting processing finishes.

In the case where the skip flag storing unit 21 is set as a result of the skip flag judgment step S50, the control unit 20 executes the earlier-mentioned next execution instruction address calculating processing S4 and compares the next execution instruction address that is calculated in the step S4 with the interim break address so as to check whether they match each other (step S51).

In the case where these addresses match each other as a result of the address comparing step S51, the control unit 20 judges that the break point is not passed through (step S53) and the passage detecting processing finishes.

In the case where these addresses do not match each other as a result of the address comparing step S51, the control unit 20 judges that the break point is passed through (step S52) and the passage detecting processing finishes.

With the above-mentioned structure, in the passage detecting processing S3, the instruction to be executed next is calculated, the interim break address is compared with the calculated address, and, as a result of the comparison, it is judged that the break should be passed through in the case where addresses do not match each other. In other words, the target program does not stop at a passage instruction even in the case where the target instruction stops at a break point, like in the case of the earlier-mentioned forced break processing, this eliminates the possibility that a break code line mark M2 is displayed on the source code line that is not executed, and thus it becomes possible to prevent the debug operator from misrecognizing like that.

Also, surely stopping the program in the case where the break point is a temporary break makes it possible to guarantee that the program stops surely at the break point in the case where the target program is executed via the execution path conceived by the program debug apparatus 2 assuming that the program debug apparatus 2 uses the break point in the internal processing such as a single step execution, and it becomes easier to use the method used for the program debug apparatus for conventional typical program executing apparatus that can surely break irrespective of the execution condition of the possible break instruction.

Further, storing the information on whether the passage judgment of the break point is performed or not for each break point becomes unnecessary because whether the passage judgment of a break point is made or not is determined depending on whether the break point is a temporary break or not, which reduces the number of pieces of information that must be attended to by a debug operator or a debugger developer, and thus the workload of the debug operator or the debugger developer is reduced.

Also, the passage detecting processing S3 includes the next execution instruction address calculating processing S4, in the case where the number of instructions to be skipped in the next execution instruction address calculating processing S4 exceeds the predetermined number, the interim break address is determined as a break address. In this way, in the case of the interim break as a break point, the effect that the program is stopped without being executed again at a break point that is located at an unpermitted point where long contiguous invalid instructions after the interim break instruction.

<Auto Flag>

Up to this point, the explanation is made assuming that a skip flag is explicitly set by a user, an auto flag mode where the value of the skip flag is automatically changed according to the display mode in the program debug apparatus 2 will be explained below.

The description of the skip flag storing unit 21 not only can be fixedly set by the debug operator as shown in FIG. 7, but also can be dynamically changed by a command input shown in FIG. 21A as an auto flag mode.

In FIG. 21A, “set skipmode, auto” is a control command for setting a skip flag to an auto flag mode, and “show skipmode” is a control command for displaying the value of the skip flag. In the figure, “Skip mode:AUTO( . . . )” is displayed as the response to indicate that it is in an auto flag mode. In the auto flag mode, the skip flag is set at 1 at the time when the source display window is selected, while the skip flag is set at 0 at the time when the source display window is not selected (or the instruction code display window is selected).

FIG. 21B is a flow chart showing the flag automatic setting processing of the control unit 20 in the auto flag mode. The control unit 20 performs the processing shown in the figure each time the display status is changed by the user operation. In other words, the control unit 20 judges whether the source display window W4 is selected or not (S101), sets a skip flag in the case where the source display window W4 is selected (S102), and resets the skip flag in the case where the source display window W4 is not selected (S103).

This flag automatic setting processing eliminates any break by an instruction whose execution condition is not satisfied in the case where the source display window is selected and the user is focused on the source code without making the user take the trouble to explicitly set the skip flag and thus enables the user to correctly grasp the location, on the C source code, where the program stops. Also, in the case where the instruction code display window is selected and the user focused on the assembler code, it becomes easier to grasp which assembler code is fetched and included in the instruction pipe line because the program stops at all the instructions.

<Compiler>

FIG. 21C is an illustration showing the outline of the compiler in this embodiment. In the figure, the compiler 40 converts the source program 10a into an object program (execution form file 11b). At that time, the compiler 40 generates debug information 11a in response to a user option specification.

FIG. 21D is a flow chart showing the compile processing in the case where there is an option specification indicating the generation of the debug information. As shown in the figure, the compiler 40 converts the source program 10a into an object program first (S90), counts the maximum number of pieces of contiguous predicated instructions in this object program (S91), generates debug information including the counted maximum number of pieces of predicated instructions (S92), and outputs the debug information to the program debug apparatus 2 and the object program to the program execution apparatus 6 (S93).

FIG. 21E shows an example of the source program 10a. FIG. 21F shows an example of the execution form file indicating the compile result of the source program by the compiler 40 in FIG. 21E. In this program example, the compiler 40 counts the maximum pieces as 4 in the above-mentioned S91. In other words, in FIG. 21E, seven predicated instructions with [F] or [!F] are placed in serial. Four predicated instructions with [F] of the seven are placed in serial and three predicated instructions with [!F] of the seven are placed in serial. In this case, the compiler 40 counts the maximum number of pieces as 4 because execution condition [F] and [!F] are in an exclusive relation.

FIG. 21G is an illustration showing an example of the debug information 11a. Line 2 in the figure shows that the number of the maximum pieces of contiguous predicated instructions in the program is 4.

This debug information 11a is set for the passage instruction counter used for detecting program run way as the above-mentioned predetermined number. In this way, the accuracy in detecting the program run way in the program debug apparatus 2 can be improved.

Note that the compile 40 may count the maximum number of pieces of contiguous predicated instructions irrespective of the description of the execution condition in the S91 in FIG. 21D. In this case, in an example of the execution form file in FIG. 21F, the maximum number is counted as 7.

Also, in FIG. 21C, the debug information 11a is outputted independently from the execution form file 11b, but it may be outputted as a content of the execution form file 11b.

### External View of the Program Debug System in the Second Embodiment

The external view of the program debug system in the second embodiment of the present invention is the same as the external view of the program debug system 5 in the first embodiment shown in the above-mentioned FIG. 2, detailed explanation on it will be omitted. Note that the program debug system in this embodiment has a program debug apparatus 202 and a program executing apparatus 206 instead of the program debug apparatus 2 and the program executing apparatus 6.

The description of the display displayed by the program debug apparatus 202 is the same as the description of the display displayed by the program debug apparatus 2 in the first embodiment shown in the above-mentioned FIG. 4, detailed explanation on it will be omitted.

<Target Program>

The target program in the second embodiment of the present invention is the same as the target program in the above-mentioned first embodiment of the present invention, detailed explanation on it will be omitted.

<Structure of the Program Executing Apparatus 206>

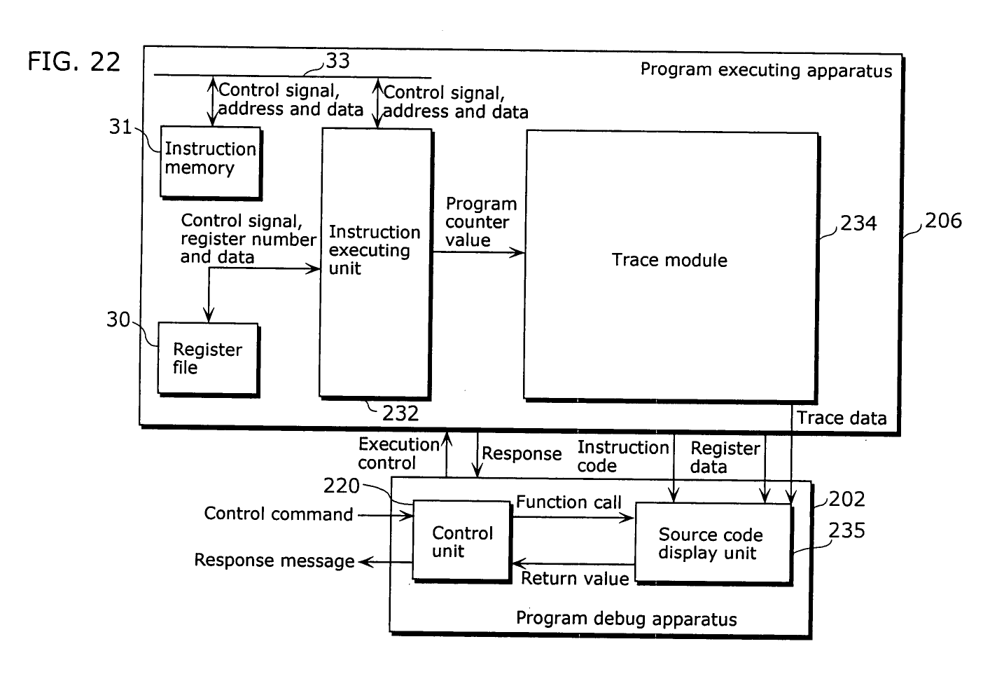

FIG. 22 shows the basic structure of the program executing apparatus 206 in the second embodiment of the present invention.

The program executing apparatus 206 in the second embodiment of the present invention comprises a register file 30, an instruction memory 31, an instruction executing unit 232, a bus 33 and a trace module 234, and the instruction executing unit 232 is the instruction executing unit 32 in the first embodiment of the present invention comprising an output unit that outputs a value of the program counter to the trace module 234 each time the instruction is executed or passed through.

The trace module 234 that received the value of the program counter from the instruction execution unit 232 stores values of the program counter in the trace memory inside the trace module 234 in sequence.

<Structure of the Program Debug Apparatus 202>

FIG. 22 shows the basic structure of the program debug apparatus 202 in the second embodiment of the present invention.

The program debug apparatus 202 comprises a control unit 220 and a source code display unit 235.

The program debug apparatus 202 receives operations by the debug operator as a control command in its internal control unit 220 via the input apparatus (not shown) like in the case of the program debug apparatus 2 in the first embodiment of the present invention. The control unit 220 returns, to the debug operator, the response message in response to the received control command via the display apparatus (not shown).

The control unit 220 executes the source code display unit 235 via a function call in the case of displaying the source code of the break location in the target program by the control command received from the debug operator. The source code display unit 235 returns the return value to the control unit 220 after displaying the source code of the break location in the target program. The control unit 220 presents the response message to the debug operator according to the return value from the source code display unit 235.

The program debug apparatus 202 can read out the instruction code from the instruction memory 31 of the program executing apparatus 206, register data from the register file 30, and further the description of the trace module 234 like in the case of the program debug apparatus 2 in the first embodiment of the present invention.

The program debug apparatus 202 can perform execution control of the target program to the program execution apparatus 206, and the program executing apparatus 206 returns response to the execution control like in the case of the program debug apparatus 2 in the first embodiment of the present invention.

Note that the part irrelevant to the present invention is not shown in the figure, but there is no problem even in the case where the program debug apparatus 202 and the program executing apparatus 206 can exchange heavier amount of data or larger number of control signals.

<Structure of the Break Source Code Line Display Processing>

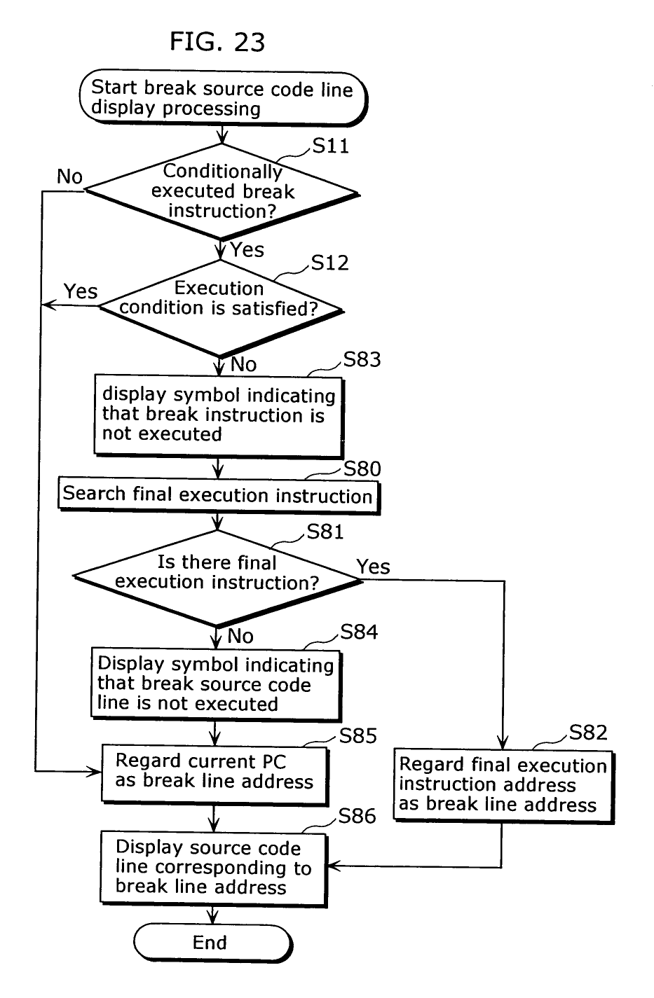

FIG. 23 shows a flow chart of the break source code display processing in the second embodiment of the present invention executed in the above-mentioned source code display unit 235.

The program debug apparatus 202 comprises step S11 for judging whether the break instruction is a predicated instruction or not and step S12 for judging whether the execution condition of the break instruction is satisfied or not, and judges whether the break instruction is a predicated instruction (that is a passage instruction) whose execution condition is not satisfied or not based on the results obtained from the step S11 and the step S12.

In the case where the break instruction is not a passage instruction as the results obtained from the step 511 and 512, step S85 where the present PC is regarded as the break line address and step S86 where the source code line corresponding to the break line address are performed so as to finish the break source code display processing.

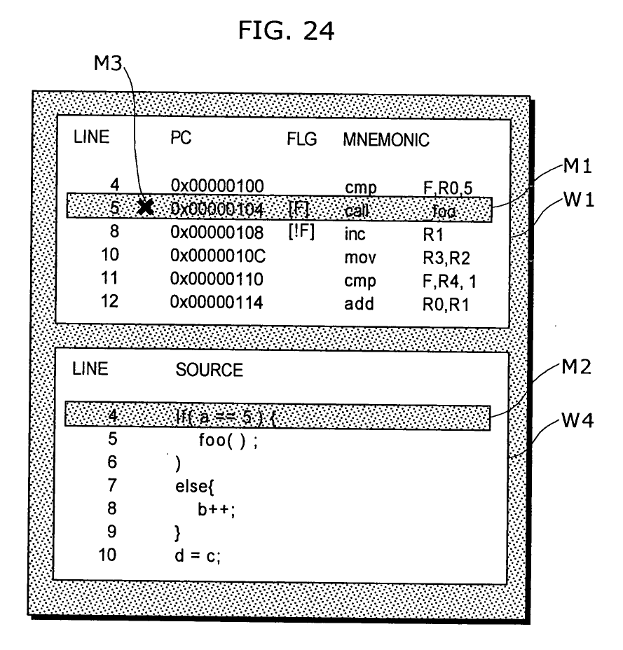

FIG. 24 shows a display example of the code display window W1 and the source display window W4 in the case where the else side in the if statement in the source code window W4 is executed.

In the status shown in FIG. 24, flag F is reset, and the instruction with [!F] is an instruction to be passed through without being executed. In other words, in the status shown in FIG. 24, the break instruction is a passage instruction.

In the case where the break instruction is a passage instruction as the results obtained from step S11 and S12, as shown in FIG. 24, the invalid instruction signal display step S83 where the invalid instruction mark M3 indicating that the break instruction is not executed is displayed at the location corresponding to the break instruction of the code window W1 is performed, and the final execution instruction search step S80 where the lastly executed instruction is searched is performed. Consequently, step S81 where judgment on whether the final execution instruction exists or not is made is performed.

In the case where a final execution instruction exists as the result of the step S81, step S82 where the address of the last execution instruction is regarded as the break line address and step S86 that is mentioned earlier are performed so as to finish the break source code display processing.

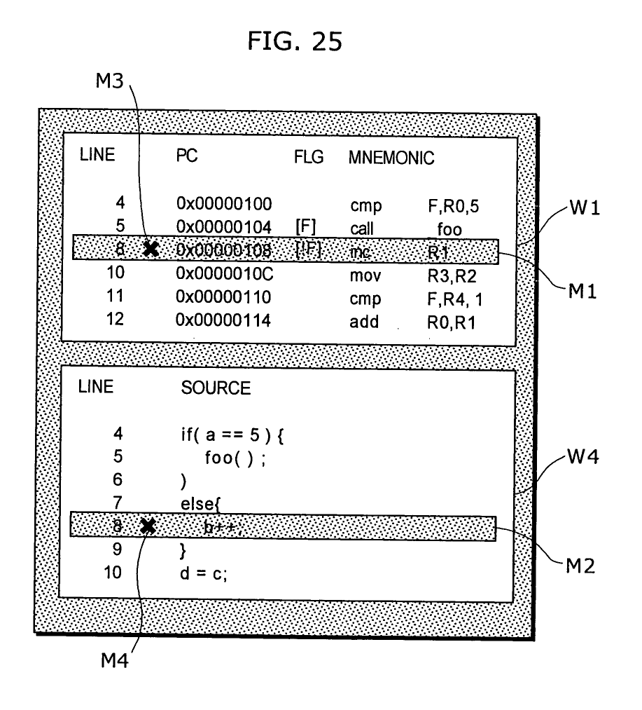

In the case where no final execution instruction exists as the result of the step S81, as shown in FIG. 25, invalid line signal display step S84 where the invalid code mark M4 indicating that the break source code line is not executed is displayed at a location corresponding to the break instruction of the source display window W4 is performed, after that, the step S85 mentioned earlier and the step S86 are performed so as to finish the break source code display processing.

In the case where the final execution instruction is successfully searched by the above-mentioned break source code display processing, as shown in FIG. 24, the break code line mark M2 is displayed on the source code line corresponding to the instruction that is finally executed even in the case where the program is stopped at an instruction not to be actually executed, which enables the debug operator to instinctively recognize which part of the source code is being executed.

Also, even in the case where the final execution instruction is not successfully searched, as shown in FIG. 25, an invalid line mark M4 is displayed even in the case where a break code line mark M2 is displayed on the source code line that is not actually executed, which enables the debug operator to easily recognize that the line indicated by the break code line mark M2 is not executed.

<Structure of the Final Execution Instruction Search Processing Step S80>

In the step S80 that is the final execution instruction search processing in the second embodiment of the present invention, the final execution instruction is searched using the trace data obtained from the trace module 234, the register data obtained from the program executing apparatus 206 and the instruction code.

As the PC of the instruction that is executed by the instruction execution unit 232 or that is passed through is included in the trace data, it is possible to specify which and in what order instructions are executed or passed through by the instruction execution unit 232 immediately before the target program stops.

In the step S80, pieces of trace data is read out one by one starting from the piece of trace data that is lastly recorded, the instruction code of the instruction shown by the PC stored in the trace data from the program executing apparatus 206, and then it is judged whether respective one of execution conditions are satisfied or not based on the register data read out from the program executing apparatus 206 in sequence.

The final execution instruction is regarded as present in the case where the execution condition shown by the read out instruction code is satisfied or the read out instruction code is the code of an non-predicated instruction, and the instruction shown by the PC stored in the read out trace data is regarded as the final execution instruction.

On the contrary, the final execution instruction is regarded as absent in the case where the final execution instruction is not found even in the case where all the stored trace data is read out or no trace data is recorded.

### External View of the Program Debug System in the Third Embodiment

The external view of the program debug system in the third embodiment of the present invention is the same as the external view of the program debug system 5 in the first embodiment shown in the above-mentioned FIG. 2, detailed explanation on it will be omitted.

The program debug system in the third embodiment of the present invention comprises a program debug apparatus 302, a program executing apparatus 306, and a connecting cable 7 that connects the program debug apparatus 302 with the program executing apparatus 306.

The description of the display displayed by the program debug apparatus 302 is the same as the description of the display displayed by the program debug apparatus 2 in the first embodiment shown in the above-mentioned FIG. 4, detailed explanation on it will be omitted.

### Target Program in the Third Embodiment

The target program in the third embodiment of the present invention is the same as the target program in the first embodiment of the above-mentioned present invention, detailed explanation on it will be omitted.

### Structure of the Program Executing Apparatus 306 in the Third Embodiment

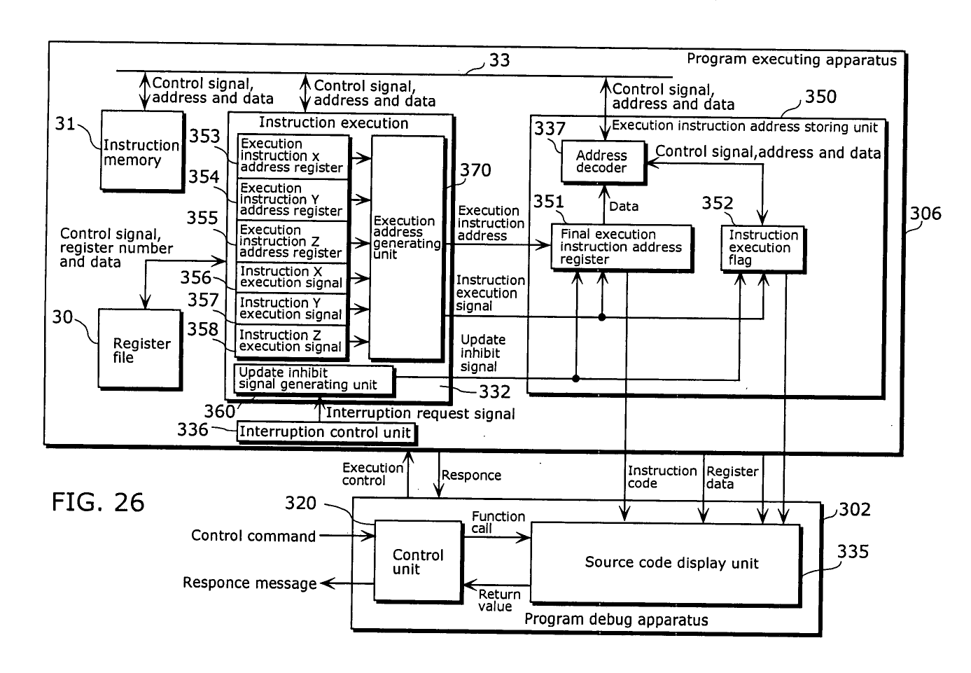

FIG. 26 shows the basic structure of the program executing apparatus 306 in the third embodiment of the present invention.

The program executing apparatus 306 in the third embodiment of the present invention comprises a register file 30, an instruction memory 31, an instruction executing unit 332, a bus 33, an execution instruction address storing unit 350 and an interruption control unit 336, and the instruction executing unit 332 is the instruction execution unit 32 in the first embodiment of the present invention including a unit (not shown) that simultaneously executes instructions up to three (for example, instruction X, Y and Z), an execution address generating unit 370, an update inhibit signal generating unit 360, an execution instruction X address register 353, an execution instruction Y address register 354, an execution instruction Z address register 355, an instruction X execution signal 356, an instruction X execution signal 357 and an instruction X execution signal 358.

Here, to simplify the explanation, the number of instructions that can be simultaneously executed by the instruction executing unit 332 is limited to 3, but the effect obtained by the present invention can be partly obtained under the condition that the number of instructions that can be simultaneously executed is 1 or more.

The execution instruction address storing unit 370 includes an address decoder 337, a final execution instruction address register 351 and an instruction execution flag 352.

The execution address generating unit 370 receives inputs from the address register 353 to 355 and execution signals 356 to 358 for each cycle and outputs execution instruction addresses and instruction execution signals to the execution instruction address storing unit 350 according to these inputs. The interruption control unit 336 outputs the interruption request signals to the instruction executing unit 332 and the outputted interruption request signals are inputted to the update inhibit signal generating unit 360.

The update inhibit signal generating unit 360 outputs the update inhibit signals to the execution instruction address storing unit 350.

The address decoder 337 in the execution instruction address storing unit 370 includes an outputting unit that outputs the description of the final execution instruction address register 351 or the description of the instruction execution flag 352 based on the control signals, addresses and data received from the bus 33 and a rewriting unit that rewrites the description of the instruction execution flag 352. In this way, the instruction executing unit 332 becomes accessible to the final execution instruction address register 351 or the instruction execution flag 352 via the bus 33.

### Structure of the Program Debug Apparatus 302 in the Third Embodiment

FIG. 26 shows the basic structure of the program debug apparatus 302 in the third embodiment of the present invention.

The program debug apparatus 302 in the third embodiment of the present invention is approximately equivalent to the program debug apparatus 202 in the second embodiment of the present invention, more specifically, the structure of the step 80 that is the final execution instruction search processing to be executed in the source code display unit 235 of the program debug apparatus 202 is different from the one in the case of the program debug apparatus 302. Therefore, explanation on the same parts in the structure of the program debug apparatus 302 as the ones in the structure of the program debug apparatus 202 will be omitted.

The program debug apparatus 302 differs from the program debug apparatus 202 in that it has a unit that reads the description of the final execution instruction address register 351 and an instruction execution flag 352 from the program executing apparatus 306.

### Operations of the Final Execution Instruction Address Register 351 in the Third Embodiment

The final execution instruction address register 351 shown in FIG. 26 is structured so that it can store addresses of the lastly executed instruction (the final execution instruction).

The final execution instruction address register 351 stores, as the address of the final execution instruction, the value to be inputted as an execution instruction address in the case where the update inhibit signal is 0 (negative) and the instruction execution signal is 1 (active), while it does not update the stored description in the case where the update inhibit signal is 1 or the instruction execution signal is 0 (negative).

Also, an address decoder 337 and a source code display unit 335 refers to the description stored in the final execution instruction address register 351 as the final execution instruction address.

### Operations of the Instruction Execution Flag 352 in the Third Embodiment

The instruction execution flag 352 shown in FIG. 26 is structured so that it can indicate that the description of the final execution instruction address register 351 is effective.

The instruction execution flag 352 becomes 1 (active) in the case where the instruction execution flag 352 itself is 0 (negative), the update inhibit signal is 0 (negative) and the instruction execution signal is 1 (active), but the instruction execution flag 352 is not updated in the other status.

Note that the case where the description of the instruction execution flag 352 is changed by the control from the address decoder 337 is excluded.

Also, the address decoder 337 and the source code display unit 335 refers to the description stored in the instruction execution flag 352.

### Structure of the Break Source Code Line Display Processing in the Third Embodiment

The break source code display processing in the third embodiment of the present invention is approximately equivalent to the break source code display processing in the second embodiment of the present invention, more specifically, only the structure of the step S80 that is the final execution instruction search processing is different. Therefore, explanation on the same parts in the structure of the break source code display processing in the third embodiment of the present invention as the ones in the structure of the break source code display processing in the second embodiment of the present invention will be omitted.

### Structure of the Final Execution Instruction Search Processing Step S80 in the Third Embodiment

In the step S80 that is the final execution instruction search processing in the third embodiment of the present invention, the final execution instruction is searched using the description of the final execution instruction address register 351 and the description of the instruction execution flag 352.

Note that the instruction execution flag 352 is initialized to 0 (negative) at the time when the target program is executed.

The source code display unit 335 reads out the instruction execution flag 352 and regards the final execution instruction as absent in the case where the description of the instruction execution flag 352 is 0 (negative). It regards the final execution instruction as present in the case where the description of the instruction execution flag 352 is 1 (active), while it reads out the description of the final execution instruction address register 351 and regards the instruction shown by the address stored in the final execution instruction address register 351 as the final execution instruction.

As explained above, in the third embodiment of the present invention, the step for searching inside the trace module is simplified and the development of the program debug apparatus 302 becomes easier.

### Structure of the Execution Address Generating Unit 370 in the Third Embodiment

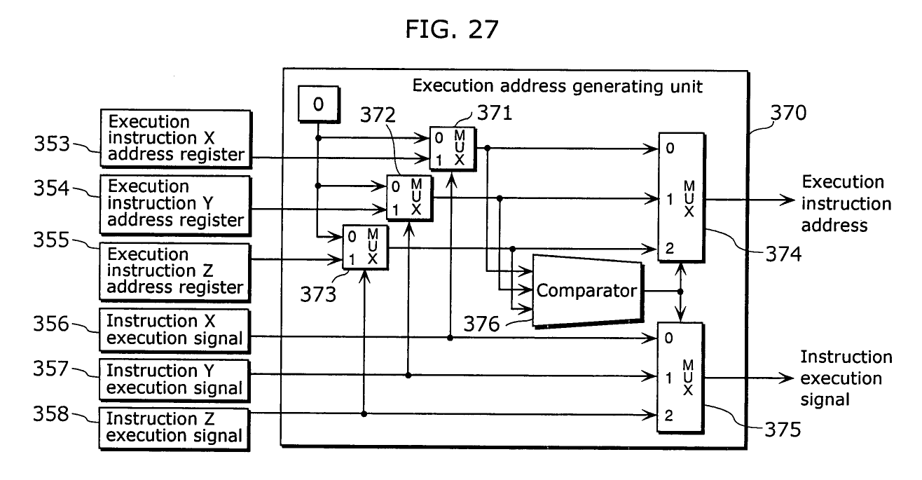

The execution address generating unit 370 in the third embodiment of the present invention shown in FIG. 27 includes multiplexers 371 to 375 and a comparator 376.

The execution instruction X address register 353 that is inputs of the execution address generating unit 370, the execution instruction Y address register 354 and the execution instruction Z address register 355 are registers storing the instruction X, Y and Z respectively that are simultaneously executed in the instruction executing unit 332.

Also, the instruction X execution signal 356 that is another input of the execution address generating unit 370, the instruction Y execution signal 357, the instruction Z execution signal 358 become 1 (active) in the case where the instruction X, Y and Z are simultaneously executed in the instruction executing unit 332, while they become 0 (negative) in the case where the instruction X, Y and Z that may be simultaneously executed in the instruction executing unit 332 are not executed, in other words, the instruction X, Y and Z are passed through.

For example, in the case where the address of the instruction X is made 0×1000, the address of the instruction Y is made 0×1004, and both the instruction X and the instruction Y are simultaneously executed, respective values mentioned earlier are as follows:

| Register | Value |
|---|---|
| Execution instruction X address register 353 | 0×1000 |
| Execution instruction Y address register 354 | 0×1004 |
| Execution instruction Z address register 355 | undefined |
| Signal | value |
| Instruction X execution signal 356 | 1 (active) |
| Instruction Y execution signal 357 | 1 (active) |
| Instruction Z execution signal 358 | 0 (negative) |

The values of the earlier-mentioned address registers 353 to 355 are inputted to the multiplexers 371 to 373 inside the execution address generation unit 370. The multiplexers 371 to 373 select the above values of the address registers 353 to 355 in the case where the above execution signals 356 to 358 are 1 (active) or 0 in the case where the above execution signals 356 to 358 are 0 (negative). The outputs of the multiplexers 371 to 373 are inputted to the comparator 376. The comparator 376 controls the multiplexer 374 to select the input of the largest value. The multiplexer 374 outputs the largest value in the outputs of the multiplexers 371 to 373.

At the same time, the comparator 376 controls the multiplexer 375 to select values of the execution signals 356 to 358 corresponding to the address registers 353 to 355 selected by the multiplexer 374.

At the same time, the comparator 376 selects the values of the execution signals 356 to 358 corresponding to the address registers 353 to 355 selected by the multiplexer 374 and outputs them via the multiplexer 375.

The largest address of the addresses of the instructions to be simultaneously executed can be stored in the final execution instruction address register 351 even in the case where the instruction executing unit 332 simultaneously executes two or more instructions by outputting, from the execution address generating unit 370, the outputs by the multiplexer 374 as the execution instruction addresses and the outputs by the multiplexer 375 as the instruction execution signals, and the break code line mark M2 to be displayed on the source code display unit can show the source code line corresponding to the last instruction in the executed instructions and can instinctively show the right source code.

Note that there is no problem even in the case of structuring the comparator 376 so that it can select any of values in the case where there are two largest values in the inputs of the comparator 376.

The instruction executing unit 332 in the third embodiment of the present invention includes an executing unit that simultaneously executes three instructions, but in the case where the instruction executing unit executes only a single instruction as another embodiment of the present invention, it is possible to regard the X address register 353 as the execution instruction address and the instruction X execution signal 356 as the instruction execution signal in FIG. 27 as they are.

Also, the instruction executing unit 332 in the third embodiment of the present invention can simultaneously execute three instructions, but it is also possible to include a unit simultaneously executes two, four or more instructions as another embodiment of the present invention.

### Structure of the Update Inhibit Signal Generating Unit 360 in the Third Embodiment

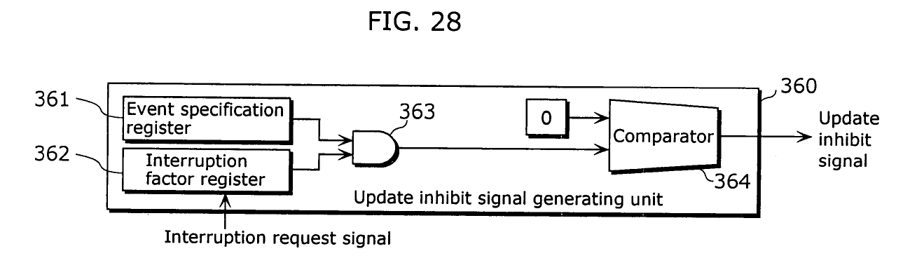

The update inhibit signal generating unit 360 in the third embodiment shown in FIG. 28 includes an event specification register 361, an interruption factor register 362, an AND circuit 363 and a comparator 364.

The interruption factor register 362 receives the interruption request signals from the interruption control unit 336 and stores them by categorizing them into each type of interruption. More specifically, the interruption factor register 362 has a plurality of bits and each bit indicates the presence or absence of the interruption request signal categorized into any type of interruption. The case where a bit shows 1 shows that there is an interruption request of the type corresponding to the bit, while the case where a bit shows 0 shows that there is no interruption request of the type corresponding to the bit.

The instruction execution unit 332 and the program debug apparatus 302 can arbitrary set the contents of the event specification register 361.

The update inhibit signal generating unit 360 takes the AND of the description of the interruption factor register 362 and the description of the event specification register 361 in the AND circuit 363, compares the result with 0 in the comparator 364, and outputs 1 (active) as the update inhibit signal in the case where the input of the comparator is not 0, or outputs 0 (negative) as the update inhibit signal in the case where the input of the comparator is 0.

In the case where the instruction in the target program becomes an error during its execution and the PC becomes the value of the interruption handler destination under the condition that the debug operator or the program debug apparatus 302 sets an exceptional interruption type that is generated by an instruction execution error in the interruption factor register 362, the final execution instruction address register 351 is not updated after the address of the instruction that caused the exception during the execution is inputted. This enables the debug operator to check the error instruction and helps the debug operator with identifying the factor of the error.

### External View of the Program Debug System in the Fourth Embodiment

The external view of the program debug system in the fourth embodiment of the present invention is the same external view of the program debug system 5 in the first embodiment shown in FIG. 2 mentioned earlier, therefore, detailed explanation on it will be omitted.

The program debug system in the fourth embodiment of the present invention comprises a program debug apparatus 402, a program executing apparatus 406 and a connecting cable 7 that connects the program debug apparatus 402 with the program executing apparatus 406.

The description of the display displayed by the program debug apparatus 402 is the same as the description of the display displayed by the program debug apparatus 2 in the first embodiment shown in FIG. 4 mentioned earlier, therefore, detailed explanation on it will be omitted.

### Target Program in the Fourth Embodiment

The target program in the fourth embodiment of the present invention is the same as the target program in the first embodiment of the present invention mentioned earlier, therefore, detailed explanation on it will be omitted.

### Structure of the Program Executing Apparatus 406 in the Fourth Embodiment

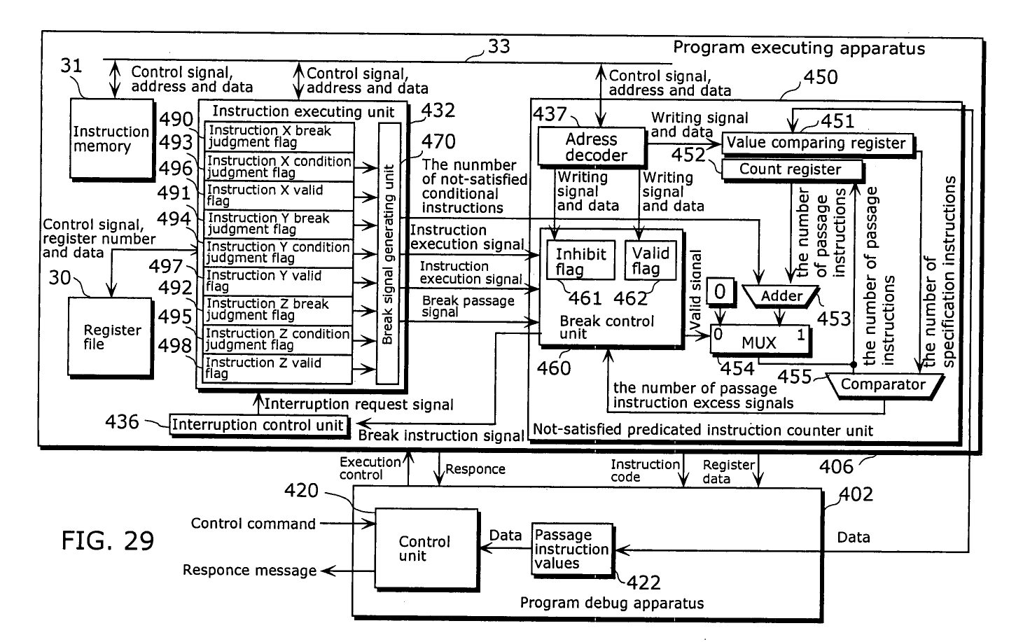

FIG. 29 shows the basic structure of the program executing apparatus 406 in the fourth embodiment of the present invention.

The program executing apparatus 406 in the fourth embodiment of the present invention comprises a register file 30, an instruction memory 31, an instruction executing unit 432, a bus 33, a not-satisfied predicated instruction counter unit 450 and an interruption control unit 436, the instruction execution unit 432 is the instruction executing unit 32 in the first embodiment of the present invention including a unit (not shown) simultaneously executes up to three instructions (for example, instruction X, Y and Z), a break signal generating unit 470, an execution instruction X break judgment flag 490, an execution instruction Y break judgment flag 491, an execution instruction Z break judgment flag 492, an instruction X condition judgment flag 493, an instruction Y condition judgment flag 494, an instruction Z condition judgment flag 495, an instruction X valid flag 496, an instruction Y valid flag 497 and an instruction Z valid flag 498.

Note that the instruction executing unit 432 in the third embodiment of the present invention has an instruction execution unit (not shown) simultaneously executes instructions regarding these instructions as instruction X, Y and Z respectively in an ascending address order, but the effect of the present invention can be partly obtained even without the instruction executing unit.

Here, to simplify the explanation, the number of instructions can be simultaneously executed by the instruction executing unit 432 is limited to three, the effect of the present invention can be partly obtained on condition that the number of instructions can be simultaneously obtained is 1 or more.

The not-satisfied predicated instruction counter unit 450 includes an address decoder 437, a value comparing register 451, a count register 452, an adder 453, a multiplexer 454, a comparator 455 and a break control unit 460.

The break control unit 460 includes an inhibit flag 461 and a valid flag 462.

The address decoder 437 in the not-satisfied execution condition counter unit 450 includes a unit rewrites the descriptions of the value comparing register 451, the inhibit flag 461 and the valid flag 462 based on the control signals, addresses and data received from the bus 33. In this way, the instruction executing unit 432 can be access the value comparing register 451, the inhibit flag 461 and the valid flag 462 via the bus 33.

The break signal generating unit 470 receives inputs from the break judgment flag 490 to 492, the condition judgment flag 493 to 495 and valid flag 496 to 498 for each cycle and outputs the number of not-satisfied conditional instructions, the instruction execution signal, the break passage signal and the break detection signal according to the inputs.

The interruption control unit 436 receives the break interruption signal from the break control unit 460 and outputs the interruption request signal to the instruction executing unit 432. The instruction executing unit 432 interrupts the execution of the instruction in response to the break interruption request signal, the program executing apparatus 406 notifies the program debug apparatus 402 of that the target program is interrupted as the response.

### Structure of the Program Debug Apparatus 402 in the Fourth Embodiment

FIG. 29 shows the basic structure of the program debug apparatus 402 in the fourth embodiment of the present invention.

The program debug apparatus 402 in the fourth embodiment of the present invention is approximately equivalent to the program debug apparatus 2 in the first embodiment of the present invention, more specifically, the program debug apparatus 402 differs from the program debug apparatus 2 in that it does not have the skip flag storing unit 21 but has the passage instruction counter 422 for setting values at the value comparing register 451 instead of the passage instruction counter 22. Therefore, the explanation on the same part in the structure of the program debug apparatus 402 as the one in the structure of the program debug apparatus 2 will be omitted.

### Structure of the Not-Satisfied Predicated Instruction Counter Unit 450 in the Fourth Embodiment

In the value comparing register 451 installed in the not-satisfied predicated instruction counter unit 450 shown in FIG. 29, values set in the passage instruction counter 422 installed in the program debug apparatus 402 are set.

The count register 452 updates the description of the count register 452 by a value outputted from the multiplexer 454 for each cycle.

The adder 453 adds the number of the not-satisfied predicated instructions outputted from the break signal generating unit to the description of the count register 452 and inputs the resulting value to the multiplexer 454.

The multiplexer 454 outputs 0 in the case where the valid signal outputted from the break control unit 460 is 0 (negative), while it outputs the input from the adder 453 in the case where the valid signal outputted from the break control unit 460 is 1 (active).

The value outputted from the multiplexer 454 and the value of the value comparing register 451 are inputted into the comparator 455, and the comparator 455 outputs 1 (active) to the break control unit 460 in the case where the value outputted from the multiplexer 454 exceeds the value of the value comparing register 451, while it outputs 0 (negative) to the break control unit 460 in the case where the value outputted from the multiplexer 454 is less than the value of the value comparing register 451.

With the above-mentioned structure, the number of not-satisfied predicated instructions is added to the value of the count register 452 in the case where the valid signal outputted from the break control unit 460 is 1 (active), and the count register 452 is reset in the case where the valid signal outputted from the break control unit 460 is 0 (negative).

In other words, the not-satisfied predicated instruction counter unit 450 is structured in a way that it counts the number of not-satisfied predicated instructions in the case where the valid signal outputted from the break control unit 460 is 1 (active) while it resets the count in the case where the valid signal outputted from the break control unit 460 is 0 (negative).

### Structure of the Break Signal Generating Unit 470 in the Fourth Embodiment

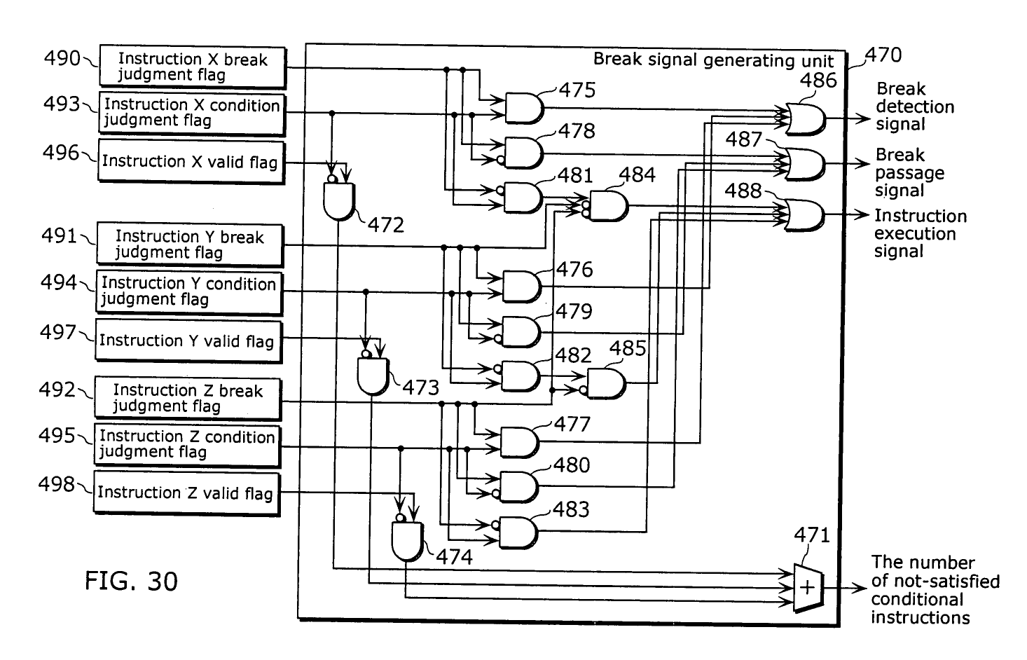

The break signal generating unit shown in FIG. 30 includes an adder 471, an AND circuit 472 to 485 and an OR circuit 486 to 488.

The instruction X break judgment flag 490 that is an input of the break signal generating unit 470, the instruction Y break judgment flag 491 and the instruction Z break judgment flag 492 show whether a code break should be generated in the instruction X, Y and Z respectively that are executed in the instruction executing unit 432. The instruction executing unit 432 sets 1 (active) in the case where a code break is generated, while it sets 0 in the case where no code break is generated. Note that 0 is set in the case where each instruction does not exist in the execution stage of the instruction executing unit 432.

The instruction X condition judgment flag 493 that is an input of the break signal generating unit 470, the instruction Y condition judgment flag 494 and the instruction Z condition judgment flag 495 show whether the execution conditions of the instruction X, Y and Z that are simultaneously executed in the instruction executing unit 432 are satisfied or not respectively. The instruction executing unit 432 sets 1 (active) in the case where each execution condition of each instruction is satisfied or each instruction is unconditional, while it sets 0 in the case where the execution condition of each instruction is not satisfied (in other words, each instruction is passed through). Note that 0 is set in the case where each instruction does not exist in the execution stage of the instruction executing unit 432.

The instruction X valid flag 496 that is the input of the break signal generating unit 470, the instruction Y valid flag 497 and the instruction Z valid flag 498 show whether the instruction X, Y and Z exist in the execution stage of the instruction executing unit 432. 1 (active) is set in the case where each instruction exists in the execution stage of the instruction executing unit 432, while 0 is set in the case where no instruction exist.

Here, “no instruction exists” means the status where no valid instruction is supplied to the execution stage of the instruction executing unit 432 because of a pipeline stall or the like.

As shown in FIG. 30, the values obtained by reversing the conditional judgment flag 493 to 495 of the respective instructions are paired with the values of the instruction valid flag 496 to 498 so as to be inputted to the AND circuits 472 to 474 respectively. The AND circuits 472 to 474 output the AND of the input respectively.

With the above-mentioned structure, the respective one of outputs of the AND circuits 472 to 474 becomes 1 in the case where a passage instruction is present or becomes 0 in the reverse case.

The values outputted from the AND circuits 472 to 474 are added in the adder 471 and outputted from the adder 471.

With the above-mentioned structure, the output of the adder 471 becomes the number of the passage instructions that are simultaneously executed.

The output of the adder 471 is sent from the break signal generating unit 470 to the break control unit 460 as the number of not-satisfied predicated instructions.

As shown in FIG. 30, the values of conditional judgment flags 493 to 495 of the respective instructions are paired with the values of the break judgment flags 490 to 492 so as to be inputted to the AND circuits 475 to 477 respectively. The AND circuits 475 to 477 output the AND of these inputs.

With the above-mentioned structure, the outputs of the AND circuits 475 to 477 becomes 1 in the case where an instruction is executed and a break is generated, while it becomes 0 in the reverse case.

The values outputted from the AND circuits 475 to 477 are inputted in the OR circuits 486 and the OR circuits 486 outputs the OR of these inputs.

With the above-mentioned structure, the output of the OR circuit 486 becomes a signal indicating whether a break is generated at any of instructions that are simultaneously executed.

The output of the OR circuit 486 is sent from the break signal generating unit 470 to the break control unit 460 as a break detection signal.

As shown in FIG. 30, the values obtained by reversing the conditional judgment flags 493 to 495 of the respective instructions are paired with the values of the break judgment flags 490 to 492 of the respective instructions so as to be inputted to the AND circuits 478 to 480 respectively. The AND circuits 478 to 480 outputs the AND of these inputs respectively.

With the above-mentioned structure, the respective one of outputs of the AND circuits 478 to 480 becomes 1 in the case where the instruction is a passage instruction and a break target or becomes 0 in the reverse case.

The values outputted from the AND circuits 478 to 480 are inputted into the OR circuit 487, and the OR circuit 487 outputs the AND of these inputs.

With the above-mentioned structure, the output of the OR circuit 487 becomes a signal indicating whether any of the instructions that are simultaneously passed through is a break target or not.

The output of the OR circuit 487 is sent from the break signal generating unit 470 to the break control unit 460 as a break passage signal.

As shown in FIG. 30, values of the condition judgment flags 493 to 495 of the respective instructions are paired with the values obtained by reversing the break judgment flags 490 to 492 of the respective instructions so as to be inputted to the AND circuits 481 to 483 respectively. The AND circuits 481 to 483 outputs the AND of these inputs.

With the above-mentioned structure, the respective one of outputs of the AND circuits 481 to 483 becomes 1 in the case where the instruction is not a break target or becomes 0 in the reverse case.

The values outputted from the AND circuit 481 and the value obtained by reversing the instruction Y break judgment flag 491 and the value obtained by reversing the instruction Z break judgment flag 492 are inputted to the AND circuit 484.

With the above-mentioned structure, the output of the AND circuit 484 becomes 1 in the case where the instruction X is executed and no break is generated at the instructions Y and Z or becomes 0 in the reverse case.

The values outputted from the AND circuit 482 and the value obtained by reversing the instruction Z break judgment flag 492 are inputted to the AND circuit 485.

With the above-mentioned structure, the output of the AND circuit 485 becomes 1 in the case where the instruction Y is executed and no break is generated at the instruction Z or becomes 0 in the reverse case.

The values outputted from the AND circuits 483 to 485 are inputted to the OR circuit 488, and the OR circuit 488 outputs the OR of these inputs.

With the above-mentioned structure, the output of the OR circuit 488 becomes a signal indicating that there is an instruction executed later than the target break instruction.

The output of the OR circuit 488 is sent from the break signal generating unit 470 to the break control unit 460 as an instruction execution signal.

In the program executing apparatus 406 where the instructions X, Y and Z are executed in an ascending address order, including the AND circuits 472 to 474 makes it possible to correctly reflect the relation between the order of instructions X, Y and Z and the target break instruction on the instruction execution signal.

The instruction executing unit 432 in the fourth embodiment of the present invention includes a unit simultaneously executes three instructions, but in the case where the instruction executing unit executes only a single instruction as another embodiment of the present invention, it is possible to keep only the apparatus for the instruction X and regard the outputs of the AND circuits 472, 475, 478 and 481 as the number of not-satisfied predicated instructions, the break detection signal, the break passage signal and the instruction execution signal respectively.

Also, the instruction executing unit 432 in the fourth embodiment of the present invention can simultaneously execute only three instructions, but it is also possible to include a unit simultaneously executes two, four or more instructions as another embodiment of the present invention.

### Structure of the Break Control Unit 460 in the Fourth Embodiment

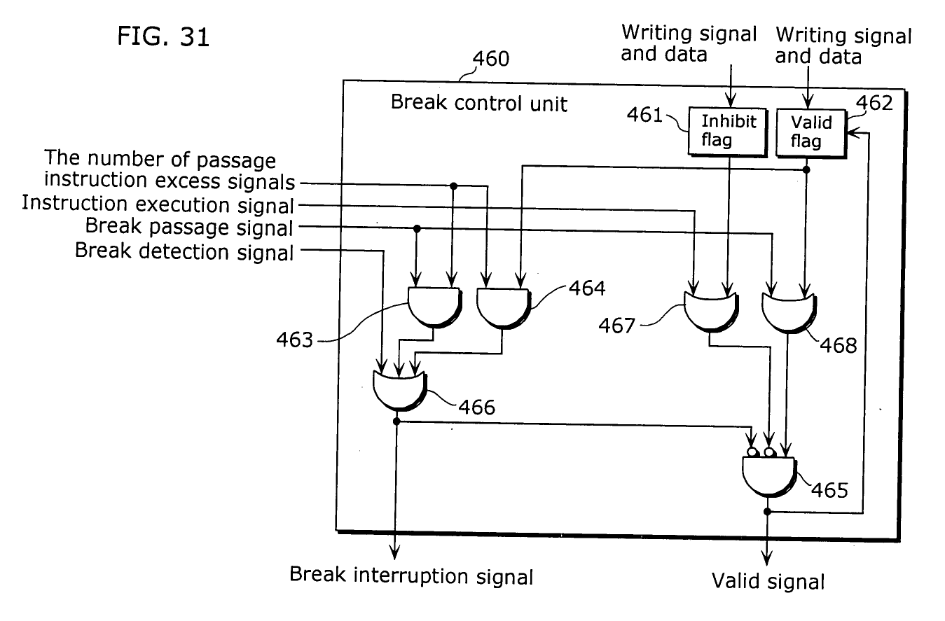

The break control unit 460 shown in FIG. 31 includes an inhibit flag 461, a valid flag 462, AND circuits 463 to 465 and OR circuits 466 to 468.

The inhibit flag 461 and the valid flag 462 can be arbitrary rewritten by the instruction executing unit 432 or the program debug apparatus 402.

At the time of executing the target program by the program debug apparatus 402, the valid flag 462 is set at 0 (negative) by the program debug apparatus 402.

The AND circuit 463 receives inputs of a break passage signal and the number of passage instruction excess signal and outputs the AND of these inputs.

With the above-mentioned structure, the output of the AND circuit 463 becomes 1 (active) at the same time of detecting the break passage signal in the case where the value of the value comparing register is set at 0.

The AND circuit 464 regards the valid flag 462 and the number of passage instruction excess signals as inputs and the AND of these inputs as the output.

With the above-mentioned structure, the output of the AND circuit 464 becomes 1 (active) in the case where the value of the count register 452 is valid and the value of the count register 452 exceeds the value of the value comparing register 451 or becomes 0 (negative) in the reverse case.

The OR circuit 466 receives inputs of the break detection signal, the AND circuit 463 and the AND circuit 464 and outputs the AND of these inputs.

The break control unit 460 makes the outputs of the OR circuit 466 as the break interruption signal.

The above-mentioned structure makes it possible to generate a break interruption signal when the break point set at the passage instruction is detected (i) at the time of detecting a break point, (ii) when the number of passage instructions exceeds the value of the value comparing register 451 under the condition that the value of the count register 452 is valid, and further (iii) the value of the value comparing register 451 is made to 0. In other words, making the value of the value comparing register 451 0 makes it possible to generate a break interruption even at the break point set at the passage instruction and easily change the function of the break point.

The OR circuit 467 receives inputs of the instruction execution signal and the inhibit flag 461 and outputs the AND of these inputs.

The OR circuit 468 receives inputs of the break passage signal and the valid flag 462 and outputs the AND of these inputs.

The AND circuit 465 receives inputs of the value obtained by reversing the output of the OR circuit 466, the value obtained by reversing the output of the OR circuit 467 and the output of the OR circuit 468, and the AND circuit 465 outputs the AND of these inputs.

The valid flag 462 receives an input of the output by the OR circuit 465 and updates the value of the valid flag 462 at the timing of the clock edge for each cycle.

With the above structure, the valid flag 462 becomes 0 (negative) in the case where the break interruption signal or the instruction execution signal becomes 1 (active) or the inhibit flag 461 is 1 (active). Also, the valid flag 462 becomes 1 (active) in the case where all the break interruption signal, instruction execution signal and inhibit flag 461 are 0 (negative) and either when the break passage signal is 1 (active) or when the valid flag 462 has already been 1 (active).

In other words, the inhibit flag 461 can inhibit the valid flag 462 from becoming 1 (active), and it is possible to make the value of the counter register 452 valid in the case where the break point set at the passage instruction is detected.

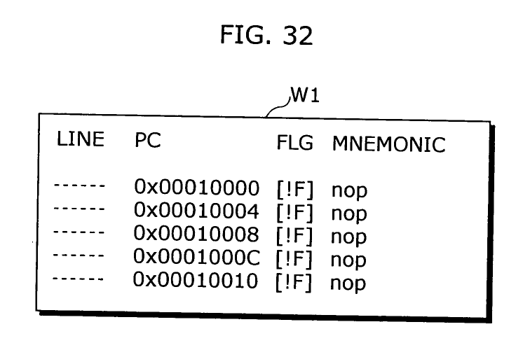

With the structure of the break control unit 460 explained above, it is possible to generate a break interruption after the number of contiguous passage instructions executed following the break point is equal to or more than the number of passage instructions set in the value comparing register 451 and the target program breaks within a certain range after passing through the break point even when a break point is placed after a possible long contiguous passage instructions as shown in FIG. 32. This eliminates the possibility that the target program breaks at a location outside the range of debug operator's expectation, and thus it is possible to improve the efficiency in the debug operation.

Note that the adder 453 adds the number of not-satisfied predicated instructions to the value of the count register 452 in the fourth embodiment of the present invention, but for example, the structure where the adder 453 adds 1 to the value of the count register 452 makes it possible to generate a break interruption unless there is an instruction to be executed in the cycle set in the value comparing register 451 after detecting the passage of the break point. This enables a break of the target program within a certain range after the passage of the break point, and thus it becomes possible to improve the efficiency in debug operation like in the case of the fourth embodiment of the present invention. Also it is possible to change the value to be added to the count register 452 in the adder 453.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

Industrial Applicability

The present invention is suitable for a program debug apparatus for debugging the program including instructions, especially predicated instructions, the program debug apparatus being connected to a data processing apparatus for executing the program or an apparatus for performing its simulation.

1. A program debug apparatus for debugging a program including a predicated instruction having an execution condition, comprising:
an instruction judgment unit operable to judge whether an instruction, throughout the program, stopped by a break condition irrelevant to the execution condition is a predicated instruction or not;
a condition judgment unit operable to judge whether the execution condition is satisfied or not in the case where the instruction is judged as a predicated instruction; and
a determination unit operable to determine the instruction as a break instruction in the case where the execution condition is judged as satisfied and determine a next instruction to be executed immediately after the instruction as a break instruction in the case where the execution condition is judged as not satisfied.

2. The program debug apparatus according to claim 1,
wherein, in the case where the execution condition is judged as not satisfied, the determination unit calculates an address of the next instruction, the next instruction being executed next earliest time and one of a predicated instruction whose execution condition is satisfied and a non-predicated instruction, and determines the calculated address as an instruction address of the break instruction.

3. The program debug apparatus according to claim 1, further comprising an execution unit operable to control program execution up to an instruction immediately before the next instruction, the next instruction being executed next earliest time and one of a predicated instruction whose execution condition is satisfied and a non-predicated instruction in the case where the execution condition of the instruction is judged as not satisfied by the condition judgment unit.

4. The program debug apparatus according to claim 3,
wherein the execution unit includes:
a conditional break setting unit operable to set a conditional break as an address of an instruction stopped by the break condition in the case where the instruction is judged as a predicated instruction by the instruction judgment unit, the conditional break breaking programs only when a target break instruction is a predicated instruction and the execution condition is satisfied;
a conditional single step execution unit operable to execute a conditional single step that breaks by step execution of the predicated instruction whose execution condition is satisfied or the non-predicated instruction; and
a break resetting unit operable to reset the conditional break that is set by the conditional break setting unit after the conditional single step execution performed by the conditional single step execution unit.

5. The program debug apparatus according to claim 1, further comprising:
a flag storing unit operable to store a flag that can be set by a user; and
an inhibiting unit operable to inhibit an operation of the instruction judgment unit, the condition judgment unit and the determination unit in the case where a predetermined value is set at the flag of the flag storing unit.

6. The program debug apparatus according to claim 5, further comprising a flag changing unit operable to change the value of the flag of the flag storing unit according to a program display status in a display unit.

7. The program debug apparatus according to claim 6,
wherein the flag changing unit sets the predetermined value at the flag in the case where a window for displaying a source program is displayed as the display status and sets a value except the predetermined value at the flag in the case where the display window of the source program is not displayed as the display status.

8. The program debug apparatus according to claim 6,
wherein the flag changing unit sets the predetermined value at the flag in the case where a display window of a source program is selected as the display status and sets a value except the predetermined value at the flag in the case where the display window of the source program is not selected as the display status.

9. The program debug apparatus according to claim 6,
wherein the flag changing unit sets the predetermined value at the flag in the case where a display window of a source program is selected as the display status and sets a value except the predetermined value at the flag in the case where the display window of an assembly program is selected as the display status.

10. The program debug apparatus according to claim 1,
wherein the instruction judgment unit makes the judgment on an instruction stopped by a break that is set under a control of the program debug apparatus without notifying a user, the break being a temporary break irrelevant to whether the execution condition is satisfied or not.

11. The program debug apparatus according to claim 1, further comprising a predetermined number storing unit operable to store a predetermined number that can be set by a user,
wherein the determination unit determines the instruction stopped by the break condition as a break instruction in the case where an execution condition of the instruction is judged as not satisfied by the condition judgment unit and the break instruction stopped by a break condition is followed by the predetermined number or more of predicated instructions whose execution conditions are not satisfied.

12. The program debug apparatus according to claim 1, further comprising:
a final execution instruction searching unit operable to search an instruction that is executed last immediately before a program break in the case where a break instruction is determined by the determination unit, the instruction being a predicated instruction whose execution condition is satisfied or a non-predicated instruction;
a break line judgment unit operable to judge at which line of a source code of a high level language the program stops based on an address of the instruction searched by the final execution instruction searching unit; and
a display control unit operable to control a display unit to display the judged line.

13. The program debug apparatus according to claim 12,
wherein the break line judgment unit judges at which line of a source code of a high level language the program stops based on an address specified by a present program counter in the case where the final execution instruction searching unit fails in searching, and
the display control unit controls the display unit to display that a source code line is not executed in the case where the final execution instruction searching unit fails in searching.

14. The program debug apparatus according to claim 1, further comprising:
an obtainment unit operable to obtain a maximum number indicating what is the maximum number of contiguous predicated instructions from debug information outputted by a compiler;
a counting unit operable to count the number of instructions indicating how many contiguous predicated instructions whose execution conditions are not satisfied are passed through; and
a break interruption generating unit operable to generate a break interruption in the case where the number of contiguous passage instructions exceeds the maximum number, the passage instructions are being predicated instructions whose execution conditions are not satisfied are passed through.

15. A data processing apparatus that is connected to a program debug apparatus and executes a target program, comprising:
an execution flag storing unit operable to store an instruction execution flag to be set in the case where a predicated instruction whose execution condition is satisfied is executed or in the case where a non-predicated instruction is executed; and
a final execution instruction address register operable to store an address of an instruction that is executed last and that is one of a predicated instruction whose execution condition is satisfied and a non-predicated instruction.

16. The data processing apparatus according to claim 15, further comprising:
an event specification register operable to specify an arbitrary selected one or more interruption factors;
an interruption factor register operable to store an interruption request signal; and
an update inhibiting unit operable to inhibit update of the final execution instruction address register and the instruction execution flag storing unit in the case where at least one of the interruption factors specified in the event specification register is corresponding to the interruption request signal stored in the interruption factor register.

17. The data processing apparatus according to claim 15, simultaneously executing a plurality of instructions and further comprising:
an address comparator operable to compare the plurality of instructions to be simultaneously executed; and
a selection output unit operable to select a largest address and output the largest address to the final execution instruction address register as a result of address comparison by the comparator.

18. The data processing apparatus according to claim 15,
wherein the data processing apparatus further comprises:
a counting unit operable to count the number of instructions indicating how many contiguous predicated instructions whose execution conditions are not satisfied are passed through; and
a break interruption generating unit operable to generate a break interruption in the case where the number of contiguous passage instructions exceeds the predetermined value.

19. The data processing apparatus according to claim 18,
wherein the data processing apparatus further comprises:
a break point passage unit operable to disable a break point set at a predicated instruction whose execution condition is not satisfied; and
an enabling unit operable to enable the counting unit after the predicated instruction whose execution condition is not satisfied passes through the break point.

20. The data processing apparatus according to claim 19,
wherein the break interruption generating unit resets the counting unit at the time when the break interruption occurs.

21. The data processing apparatus according to claim 20, further comprising a disabling unit operable to disable the counting unit, in the case where an address of the target instruction of the break point is smaller than an address of one of a predicated instruction and a non-predicated instruction during a simultaneous execution of (i) the target instruction of a break point passed through by the break point passage unit and (ii) one of the predicated instruction whose execution condition is satisfied and the non-predicated instruction.

22. A data processing apparatus that is connected to a program debug apparatus and executes a target program, comprising:
a counting unit operable to count the number of instructions indicating how many predicated instructions whose execution conditions are not satisfied are passed through contiguously; and
a break interruption generating unit operable to generate a break interruption in the case where the number of contiguous passage instructions exceeds a predetermined value.

23. A compiler operable to generate an object program based on a source program, comprising:
a counting unit operable to count a maximum number indicating what is the maximum number of contiguous predicated instructions in the generated object program; and
a generation unit operable to generate debug information including the maximum number.

24. A program debug method for debugging a program including a predicated instruction having an execution condition, comprising:
an instruction judging step of judging whether an instruction, throughout the program, stopped by a break condition irrelevant to the execution condition is a predicated instruction or not;
a condition judging step of judging whether the execution condition is satisfied or not in the case where the instruction is a predicated instruction; and
a determination step of determining the instruction as a break instruction in the case where the execution condition of the instruction is judged as satisfied or a next instruction to be executed immediately after the instruction as a break instruction in the case where the execution condition of the instruction is judged as not satisfied.

25. A program for causing a computer to function as each unit in a program debug apparatus according to claim 1.

26. A target program to be debugged by a program debug apparatus, the target program containing debug information indicating a maximum number indicating what is the maximum number of contiguous predicated instructions in the target program.
